(19) United States
(12) Patent Application Publication
(10) Pub. No.: US 2015/0072170 A1
(43) Pub. Date: Mar. 12, 2015

(54) FUSION WELDABLE FILLER ALLOYS

(71) Applicant: ALCOA INC., Pittsburgh, PA (US)

(72) Inventors: Jen C. Lin, Export, PA (US); Israel Stol, Pittsburgh, PA (US); Kyle L. Williams, Shelocta, PA (US)

(21) Appl. No.: 14/546,202

(22) Filed: Nov. 18, 2014

Related U.S. Application Data
(63) Continuation of application No. 12/623,709, filed on Nov. 23, 2009, now abandoned.
(60) Provisional application No. 61/117,402, filed on Nov. 24, 2008.
(60) Provisional application No. 61/117,426, filed on Nov. 24, 2008.

(51) Int. Cl. B23K 35/28; B23K 20/233; B32B 15/01

(52) U.S. Cl. CPC B23K 35/286; B32B 15/016; B23K 35/288; B23K 20/2336
USPC 428/654; 420/542; 420/541; 420/543; 228/256

(57) ABSTRACT

Al—Mg and Al—Mg—Zn weld filler alloy compositions for use with fusion weldable 7xxx, 6xxx, 5xxx and 2xxx series aluminum alloy base metals are disclosed. The weld filler alloys may be used for joining a first aluminum base metal segment to a second aluminum base metal segment, where the base metal segments is at least one of 7xxx, 6xxx, 5xxx and 2xxx series aluminum alloy. The weld filler alloys, in wire or rod form, may also be used to repair a defective weld.

### CROSS-REFERENCE TO RELATED APPLICATIONS

This application claims priority to U.S. Provisional. Application. Ser. Nos. 61/117,402 and 61/117,426, both filed Nov. 24, 2008, each of which is incorporated by reference herein in their entireties for all purposes.

### BACKGROUND

Aluminum base metals are used in a variety of industries including marine, defense, automotive, railroad, transportation, aerospace, liquefied natural gas, oil and gas, among others. Common to all of these industries is the need to weld parts together with fusion based and/or solid state based welding processes.

### SUMMARY

The present disclosure relates to improved weld filler alloys useful in welding 2xxx, 5xxx, 6xxx and/or 7xxx wrought aluminum alloys. The weld filler alloy embodiments disclosed herein may be utilized in the following industries including without limitation: (a) marine (e.g., ship hulls and other sub-structures), (b) defense (e.g., armored vehicles for high strength and/or blast resistance), (c) aerospace (e.g., plane wings fabricated out of Aluminum Association (AA) 2099 aluminum alloy or AA 7085 aluminum alloy, among other 2xxx and/or 7xxx series aluminum alloys according to the AA designation), (d) automotive, rail and transportation (e.g., sub-structures fabricated out of 6013 aluminum alloy or AA 5083 aluminum alloy, among other 6xxx and/or 5xxx series aluminum alloys and/or extrusions welded together), and (e) oil and gas (e.g., risers and oil platforms produced out of 7xxx series aluminum alloys and/or extrusions thereof welded together).

In some instances, the weld filler alloy embodiments may be utilized in the welding of parts (e.g., plates, extrusions, sheets, forgings) using fusion-based welding processes (e.g., gas metal arc welding, gas tungsten are welding) and/or solid-state based welding processes (e.g., friction stir welding, friction welding).

In some embodiments, the weld filler alloy is in the form of a wire or a rod. In one embodiment, the weld filler alloy has a solidus temperature that is lower than the solidus temperature of the aluminum base metal segments or the aluminum base metals. In one embodiment, the weld filler alloy has a solidus temperature that is lower than the solidus temperature of the aluminum base metal segments or the aluminum base metals. In one embodiment, the weld filler alloy, upon fusion welding and dilution with the base metal segments or base metals being welded together, results in a weld metal whose solidus temperature is lower than the solidus temperatures of the base metal segments or each of the base metals being welded together, at any solid/liquid fraction during the solidification of the weld.

In one embodiment, a weld filler alloy includes from about 5.6 wt. % Mg to about 8.0 wt. % Mg, from about 0.01 wt. % to about 0.5 wt. % of a grain refiner, and up to about 94.4 wt. % Al. In one embodiment, the weld filler alloy includes from about 5.6 wt. % Mg to about 6.2 wt. % Mg. In one embodiment, the weld filler alloy includes about 5.9 wt. % Mg.

In one embodiment, the weld filler alloy includes from about 0.05 wt. % Zn to about 3.5 wt. % Zn. In one embodiment, the weld filler alloy includes from about 1.7 wt. Zn to about 2.3 wt. % Zn. In one embodiment, the weld filler alloy includes about 2.0 wt. % Zn.

In one embodiment, the grain refiner is at least one of Zr, Ti and B. In one embodiment, the weld filler alloy is substantially free of Mn.

In one embodiment, a weld filler alloy consists essentially of from about 5.6 wt. % Mg to about 8.0 wt. % Mg, from about 0.01 wt. % to about 0.5 wt. % of a grain refiner, and the balance aluminum, incidental elements and impurities.

In one embodiment, a weld filler alloy consists essentially of from about 5.6 wt. % Mg to about 8.0 wt. % Mg, from about 0.05 wt. % Zn to about 3.5 wt. % Zn, from about 0.01 wt. % to about 0.5 wt. % of a grain refiner, and the balance aluminum, incidental elements and impurities.

In one embodiment, an aluminum alloy product includes a first aluminum alloy segment, a second aluminum alloy segment, and a weldment joining the first aluminum alloy segment to the second aluminum alloy segment, where the weldment includes a weld filler alloy having from about 5.6 wt. % Mg to about 8.0 wt. % Mg, from about 0.01 wt. % to about 0.5 wt. % of a grain refiner, and up to about 94.4 wt. % Al.

In one embodiment, the weld filler alloy includes from about 0.05 wt. % Zn to about 3.5 wt. % Zn. In one embodiment, each of the first aluminum alloy segment and the second aluminum alloy segment is at least one of a 6xxx, 5xxx, 7xxx and 2xxx series aluminum alloy. In one embodiment, the weldment achieves cracks of not greater than about 0.1 mm.

In one embodiment, a method of welding aluminum products includes (a) providing first aluminum product and second aluminum product proximal to each other, (b) providing a weld filler alloy proximal to the first aluminum product and the second aluminum product, where the weld filler alloy includes from about 5.6 wt. % Mg to about 8.0 wt. % Mg, from about 0.01 wt. % to about 0.5 wt. % of a grain refiner, and up to about 94.4 wt. % Al, and (c) welding the first aluminum product and the second aluminum product together by at least one of melting and fusing the first aluminum product, the second aluminum product and the weld filler alloy, where the solidus temperature of the weld filler alloy is lower than the solidus temperature of the first aluminum product and the second aluminum product.

Other variations, embodiments and features of the present disclosure will become evident from the following detailed description, drawings and claims.

### BRIEF DESCRIPTION OF THE DRAWINGS

For a fuller understanding of the disclosure, reference is made to the following description taken in connection with the accompanying drawing(s), in which:

FIG. 1 illustrates a comparison of solidus temperatures between an AA 7085 aluminum alloy base metal and weldments produced with an AA 5356 weld filler alloy at different solid/liquid fractions, with varying percentage of dilution of the AA 7085 base metal and the AA 5356 weld filler alloy within the weldments;

FIG. 2 illustrates a comparison of solidus temperatures between an AA 7085 aluminum alloy base metal and weldments produced with an AA 5183 weld filler alloy at different solid/liquid fractions, with varying percentage of dilution of the AA 7085 base metal and the AA 5183 weld filler alloy within the weldments;

FIG. 3 illustrates a comparison of solidus temperatures between an AA 7085 aluminum alloy base metal and weldments produced with an AA 5556 weld filler alloy at different solid/liquid fractions, with varying percentage of dilution of the AA 7085 base metal and the AA 5556 weld filler alloy within the weldments;

FIG. 4 illustrates a comparison of solidus temperatures between an AA 7085 aluminum alloy base metal and weldments produced with an AA 4043 weld filler alloy at different solid/liquid fractions, with varying percentage of dilution of the AA 7085 base metal and the AA 4043 weld filler alloy within the weldments;

FIG. 5 illustrates a comparison of solidus temperatures between an AA 7085 aluminum alloy base metal and weldments produced with an AA 4145 weld filler alloy at different solid/liquid fractions, with varying percentage of dilution of the AA 7085 base metal and the AA 4145 weld filler alloy within the weldments;

FIG. 6 illustrates a comparison of solidus temperatures between an AA 7085 aluminum alloy base metal and weldments produced with Al—Mg weld filler alloy according to one embodiment of the present disclosure at different solid/liquid fractions, with varying percentage of dilution of the AA 7085 base metal and the Al—Mg weld filler alloy within the weldments;

FIGS. 7A and 7B are etched and anodized cross-sectional micrographs, respectively, of a weldment produced with an AA 7085 aluminum alloy base metal and an AA 5356 aluminum alloy filler wire;

FIGS. 8A and 8B are etched and anodized cross-sectional micrographs, respectively, of a weldment produced with a modified AA 7085 aluminum alloy base metal and an Al—Mg weld filler wire in accordance with one embodiment of the present disclosure;

FIG. 9 is a photograph of an end-constrained double tee-fillet weldment produced with an AA 7085 aluminum alloy base metal and an AA 5356 aluminum alloy filler wire;

FIG. 10 is a photograph of an end-constrained double tee-fillet weldment produced with a modified AA 7085 aluminum alloy base metal and an Al—Mg weld filler wire in accordance with one embodiment of the present disclosure;

FIG. 11 is a cross-sectional macrograph through a weldment produced with an AA 7085 aluminum alloy base metal and an Al—Mg weld filler wire in accordance with one embodiment of the present disclosure;

FIG. 12 is a cross-sectional macrograph through a weldment produced with a modified AA 7085 aluminum alloy base metal and an Al—Mg weld filler wire in accordance with one embodiment of the present disclosure;

FIG. 13 illustrates a comparison of solidus temperatures between an AA 6013 aluminum alloy base metal and weldments produced with an AA 5356 weld filler alloy at different solid/liquid fractions, with varying percentage of dilution of the AA 6013 base metal and the AA 5356 weld filler alloy within the weldments;

FIG. 14 illustrates a comparison of solidus temperatures between an AA 6013 aluminum alloy base metal and weldments produced with Al—Mg weld filler alloy according to one embodiment of the present disclosure at different solid/liquid fractions, with varying percentage of dilution of the AA 6013 base metal and the Al—Mg weld filler alloy within the weldments;

FIG. 15 is a cross-sectional micrograph of a weldment produced with an AA 6013 aluminum alloy base metal and an AA 5356 aluminum alloy weld filler wire;

FIG. 16 is a cross-sectional micrograph a weldment produced with an AA 6013 aluminum alloy base metal and an Al—Mg weld filler wire in accordance with one embodiment of the present disclosure;

FIGS. 17A-17D are two sets of cross-sectional micrographs of weldments produced with an AA 6013 aluminum alloy and an AA 5356 weld filler wire;

FIGS. 18A-18D are two sets of cross-sectional micrographs of weldments produced with an AA 6013 aluminum alloy and a modified AA 5356 weld filler wire;

FIGS. 19A-19D are two sets of cross-sectional micrographs of weldments produced with an AA 6013 aluminum alloy and an AA 4043 weld filler wire;

FIGS. 20A and 20B are cross-sectional micrographs of a weldment produced with an AA 6013 aluminum alloy and an Al—Mg weld filler wire in accordance with one embodiment of the present disclosure;

FIG. 21 illustrates a comparison of solidus temperatures between an AA 2099 aluminum alloy base metal and weldments produced with an AA 4043 weld filler alloy at different solid/liquid fractions, with varying percentage of dilution of the AA 2099 base metal and the AA 4043 weld filler alloy within the weldments;

FIG. 22 illustrates a comparison of solidus temperatures between an AA 2099 aluminum alloy base metal and weldments produced with an AA 4145 weld filler alloy at different solid/liquid fractions, with varying percentage of dilution of the AA 2099 base metal and the AA 4145 weld filler alloy within the weldments;

FIG. 23 illustrates a comparison of solidus temperatures between an AA 2099 aluminum alloy base metal and weldments produced with an AA 5356 weld filler alloy at different solid/liquid fractions, with varying percentage of dilution of the AA 2099 base metal and the AA 5356 weld filler alloy within the weldments;

FIG. 24 illustrates a comparison of solidus temperatures between an AA 2099 aluminum alloy base metal and weldments produced with Al—Mg weld filler alloy according to one embodiment of the present disclosure at different solid/liquid fractions, with varying percentage of dilution of the AA 2099 base metal and the Al—Mg weld filler alloy within the weldments;

FIG. 25 illustrates a comparison of solidus temperatures between an AA 2099 aluminum alloy base metal and weldments produced with Al—Mg—Zn weld filler alloy according to one embodiment of the present disclosure at different solid/liquid fractions, with varying percentage of dilution of the AA 2099 base metal and the Al—Mg—Zn weld filler alloy within the weldments;

FIG. 26 comprises a plurality of photographs of bend specimens of AA 6013 aluminum alloy base metal welded with an AA 4043 weld filler alloy; and

FIG. 27 comprises a plurality of photographs of bend specimens of AA 6013 aluminum alloy base metal welded with an Al—Mg weld filler alloy according to one embodiment of the present disclosure.

### DETAILED DESCRIPTION

It will be appreciated by those skilled in the art that the presently disclosed embodiments are considered in all respects to be illustrative and not restrictive.

When referring to any numerical range of values, such ranges are understood to include each and every number and/or fraction between the stated range minimum and maximum. A range of from about 5.6 wt. % Mg to about 8.0 wt. % Mg, for example, would expressly include all intermediate values of 5.6 wt. %, 5.7 wt. %, 5.8 wt. % and 5.9 wt. %, all the way up to and including 8.0 wt. %. The same applies to each other numerical property, thermal treatment practice (e.g., temperature) and/or elemental range set forth herein.

Except where stated otherwise, the expression “up to” when referring to the amount of an element means that that elemental composition is optional and includes a zero amount of that particular compositional component. Unless stated otherwise, all compositional percentages are in weight percent (wt. %).

Aluminum alloys including the likes of AA 7085, AA 7040, AA 7140, AA 6013, AA 5083 and AA 2099, among others, may present challenges in welding to other aluminum alloys or to each other (e.g., repairing or joining two similar segments together). For example, it may be challenging to weld a first AA 7085 aluminum alloy base metal segment to a second. AA 7085 aluminum alloy base metal segment, or to weld an AA 6013 aluminum alloy base metal segment to an AA 5083 aluminum alloy base metal segment, with conventional fusion-based welding processes (e.g., gas tungsten arc welding (GTAW), gas metal arc welding (GMAW)) because of hot cracking and solidification.

As used herein, “AA 7085” means aluminum alloy 7085 as defined by the Aluminum Association Teal Sheets. Likewise, “AA 7040,” “AA 7140,” “AA 6013,” “AA 5083,” and “AA 2099” mean aluminum alloys 7040, 7140, 6013, 5083 and 2099, respectively, as defined by the Aluminum Association Teal Sheets.

The term “base metal” means the aluminum parts (e.g., plates, sheets, extrusions, forgings) to be welded. Types of base metals that may be used in the present disclosure include, but are not limited to, 2xxx, 5xxx, 6xxx, and 7xxx series aluminum alloys (Aluminum Association designations). As used herein, “2xxx” means aluminum alloys of the 2xxx series as designated by the Aluminum Association. Likewise, “5xxx,” “6xxx,” and “7xxx” mean aluminum alloys of the 5xxx, 6xxx and 7xxx series, respectively, as designated by the Aluminum Association.

In one embodiment, the present disclosure relates to Al—Mg weld filler alloys and methods of using the same. In one embodiment, the present disclosure relates to Al—Mg—Zn weld filler alloys and methods of using the same. The weld filler alloys may facilitate improved welding characteristics, such as when employed with at least one of Al—Cu alloy product, Al—Mg alloy product, Al—Mg—Si alloy product and Al—Zn/Cu alloy product.

As used herein, “weld filler alloy” means an alloy added to a molten pool formed at a joint between the base metals being welded together for providing a desired composition, geometry and size of a weld (e.g., weldment) upon solidification. The terms weld, weldment and weld deposit can be used interchangeably to represent a weld.

Examples of Al—Cu alloy product include any of the AA 2xxx series alloys. In one example, the Al—Cu alloy product is AA 2099. Examples of Al—Mg alloy products include any of the AA 5xxx series alloys. In one example, the Al—Mg alloy product is AA 5083. Examples of Al—Mg—Si alloy products include any of the AA 6xxx series alloys. In one example, the Al—Mg—Si alloy product is AA 6013. Examples of Al—Zn/Cu alloy products include any of the AA 7xxx series alloys, including Al—Zn, Al—Zn—Cu, Al—Zn—Mg, or Al—Zn—Cu—Mg, among other similar alloys. In some examples, the Al—Zn/Cu alloy product is AA 7085, AA 7040 and AA 7140.

In one embodiment, the Al—Mg weld filler alloy or the Al—Mg—Zn weld filler alloy is used to repair an existing aluminum alloy product, such as an Al—Mg or Al—Mg—Si alloy product, among others. In one embodiment, the Al—Mg weld filler alloy or the Al—Mg—Zn weld filler alloy is used for forming a weldment joining at least two aluminum alloy segments. In one embodiment, the Al—Mg weld filler alloy or the Al—Mg—Zn weld filler alloy is used for welding two aluminum products together (e.g., two base metal segments). For example, the Al—Mg weld filler alloy or the Al—Mg—Zn weld filler alloy is used for joining at least two base metal segments including the likes of AA 5083 and AA 6013, or AA 6013 and AA 7085, or AA 6013 and AA 6013, or AA 7085 and AA 7085, or AA 2099 and AA 2099, or AA 6013 and AA 2099, among other variations or permutations of the 2xxx, 5xxx, 6xxx and 7xxx series aluminum alloys.

Aluminum alloy products containing Al—Cu, Al—Mg, Al—Mg—Si and Al—Zn/Cu have predominant amount of at least one Al—Cu alloy, one Al—Mg alloy, one Al—Mg—Si alloy, and one Al—Zn/Cu alloy, respectively. The aluminum alloy products may be wrought products (e.g., rolled products, extrusions, forgings) or cast products (e.g., castings). In one example, an aluminum alloy product to be joined or repaired may be a mold plate product. A mold plate is a plate that is used for injection mold parts. In other embodiments, the aluminum alloy products to be repaired or joined may include base metal segments, sections, and parts, among others. Use of the disclosed Al—Mg weld filler alloy or Al—Mg—Zn weld filler alloy may facilitate repairing or joining of the aluminum alloy products by improving, for example, one or more of appearance and/or functionality of the repaired or joined portion of the aluminum alloy product, as described in further detail below.

The Al—Mg weld filler alloys of the instant application are those alloys containing a predominant amount of at least one Al—Mg alloy. The Al—Mg—Zn weld filler alloys of the instant application are those alloys containing a predominant amount of at least one Al—Mg—Zn alloy. In one embodiment, a weld filler alloy is an alloy that is used to repair an aluminum alloy product. In one embodiment, a weld filler alloy is an alloy that is used to join base metal segments together. The weld filler alloys may be in the form of rods, wires, and powders that can be clad over a repair area (e.g., with the aid of a laser beam welding process). Other weld filler alloy forms may also be utilized. In some embodiments, weld filler wires or rods may be used for repairing a defective weld or a defective aluminum alloy product or base metal.

Al—Mg alloys are aluminum alloys comprising magnesium as a primary alloying constituent. Al—Mg—Zn alloys are aluminum alloys comprising magnesium and zinc as primary alloy constituents.

In some embodiments, the Al—Mg and Al—Mg—Zn weld filler alloys disclosed herein have achieved comparable (or even better) welding characteristics than that of AA 5083 and AA 5183. In other words, the Al—Mg and Al—Mg—Zn weld filler alloys have better weldability than AA 5083 and AA 5183 weld filler alloys for welding 2xxx, 5xxx, 6xxx and 7xxx series aluminum alloys to each other, and to themselves. In some embodiments, the Al—Mg and Al—Mg—Zn weld filler alloys have achieved comparable (or even better) appearance characteristics (e.g., color match, cracking, texture), among other properties, than AA 5083 and AA 5183.

In some embodiments, the Al—Mg and Al—Mg—Zn weld filler alloys disclosed herein have achieved comparable (or even better) functional characteristics (e.g., shear strength, longitudinal tensile strength, transverse tensile strength, elongation, abrasion resistance, durability, shock resistance, wear resistance, pitting adhesion, porosity, hardness, thermal shock, impact resistance), among others, than that of AA 4043 weld filler alloy. For example, Al—Mg weld filler alloy and Al—Mg—Zn weld filler alloy may have better mechanical properties than AA 4043 for welding 2xxx, 5xxx, 6xxx and 7xxx series aluminum alloys to each other, and to themselves. In some embodiments, AA 4043 may have similar weldability as the Al—Mg weld filler alloy or the Al—Mg—Zn weld filler alloy disclosed herein. However, AA 4043 cannot achieve the mechanical properties, among other properties, of an Al—Mg weld filler alloy or an Al—Mg—Zn weld filler alloy.

Aluminum alloys AA 4043, AA 5083 and AA 5183 mean Aluminum Association alloys 4043, 5083 and 5183, respectively, as defined by the Aluminum Association Teal Sheets.

In some instances, the Al—Mg and Al—Mg—Zn weld filler alloys may also achieve comparable characteristics as described above over other weld filler alloys including AA 1100, AA 2319, AA 4145, AA 5354, AA 5356, AA 5554, AA 5556, and AA 5654, among others.

In some embodiments, the Al—Mg and Al—Mg—Zn weld filler alloys disclosed herein may exhibit weldability similar to those of 4xxx series aluminum alloys (e.g., AA 4043) and achieve mechanical characteristics similar to those of 5xxx series aluminum alloys (e.g., AA 5356) at the same time.

Aluminum alloys AA 1100, AA 2319, AA 4145, AA 5354, AA 5356, AA 5554, AA 5556 and AA 5654 mean Aluminum Association alloys 1100, 2319, 4145, 5354, 5356, 5554, 5556 and 5654, respectively, as defined by the Aluminum Association Teal Sheets.

Some embodiments of Al—Mg and Al—Mg—Zn weld filler alloys useful in accordance with the instant disclosure are disclosed in Table 1 below.

TABLE 1
Embodiments of Al—Mg and Al—Mg—Zn Weld Filler Alloys

| | Mg | Zn | Grain Refiner | Al |
|---|---|---|---|---|
| Al—Mg—X1 | 5.6-8.0 | 0 | 0.01-0.5 | Balance |
| Al—Mg—X2 | 5.6-6.2 | 0 | 0.01-0.5 | Balance |
| Al—Mg—X3 | 5.9 | 0 | 0.01-0.5 | Balance |
| Al—Mg—Zn—Y1 | 5.6-8.0 | 0.05-3.5 | 0.01-0.5 | Balance |
| Al—Mg—Zn—Y2 | 5.6-6.2 | 1.7-2.3 | 0.01-0.5 | Balance |
| Al—Mg—Zn—Y3 | 5.9 | 2.0 | 0.01-0.5 | Balance |

Al—Mg—X1 comprises (and in some instances consists essentially of) from about 5.6 wt. % Mg to about 8.0 wt. % Mg, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—X1 includes up to about 94.4 wt. % Al.

Al—Mg—X2 comprises (and in some instances consists essentially of) from about 5.6 wt. % Mg to about 6.2 wt. % Mg, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—X2 includes up to about 94.4 wt. % Al.

Al—Mg—X3 comprises (and in some instances consists essentially of) about 5.9 wt. % Mg, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—X3 includes up to about 94.1 wt. % Al.

Al—Mg—Zn—Y1 comprises (and in some instances consists essentially of) from about 5.6 wt. % Mg to about 8.0 wt. % Mg, from about 0.05 wt. % Zn to about 3.5 wt. % Zn, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—Y1 includes up to about 94.4 wt. % Al.

Al—Mg—Zn—Y2 comprises (and in some instances consists essentially of) from about 5.6 wt. % Mg to about 6.2 wt. % Mg, from about 1.7 wt. % Zn to about 2.3 wt. % Zn, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—Y2 includes up to about 92.7 wt. % Al.

Al—Mg—Zn—Y3 comprises (and in some instances consists essentially of) about 5.9 wt. % Mg, about 2.0 wt. % Zn, from about 0.01 wt. % to about 0.05 wt. % of a grain refiner, the balance essentially aluminum, incidental elements and impurities. In one embodiment, the grain refiner is at least one of Zr, Ti and B, among others. In another embodiment, Al—Mg—Y3 includes up to about 92.1 wt. % Al.

In some embodiments, the Mg content of the weld filler alloy composition may be at least about 5.6 wt. %, or at least about 5.7 wt. %, or at least about 5.8 wt. %, or at least about 5.9 wt. %, or at least about 6.0 wt. %, or at least about 6.1 wt. %, or at least about 6.2 wt. %, or at least about 6.3 wt. %, or at least about 6.4 wt. %, or at least about 6.5 wt. %, or at least about 6.6 wt. %, or at least about 6.7 wt. %, or at least about 6.8 wt. %, or at least about 6.9 wt. %, or at least about 7.0 wt. %, or at least about 7.1 wt. %, or at least about 7.2 wt. %, or at least about 7.3 wt. %, or at least about 7.4 wt. %, or at least about 7.5 wt. %, or at least about 7.6 wt. %, or at least about 7.7 wt. %, or at least about 7.8 wt. %, or at least about 7.9 wt. %, or at least about 8.0 wt. %.

In some embodiments, the Mg content of the weld filler alloy composition may be not greater than about 8.0 wt. %, or not greater than about 7.9 wt. %, or not greater than about 7.8 wt. %, or not greater than about 7.7 wt. %, or not greater than about 7.6 wt. %, or not greater than about 7.5 wt. %, or not greater than about 7.4 wt. %, or not greater than about 7.3 wt. %, or not greater than about 7.2 wt. %, or not greater than about 7.1 wt. %, or not greater than about 7.0 wt. %, or not greater than about 6.9 wt. %, or not greater than about 6.8 wt. %, or not greater than about 6.7 wt. %, or not greater than about 6.6 wt. %, or not greater than about 6.5 wt. %, or not greater than about 6.4 wt. %, or not greater than about 6.3 wt. %, or not greater than about 6.2 wt. %, or not greater than about 6.1 wt. %, or not greater than about 6.0 wt. %, or not greater than about 5.9 wt. %, or not greater than about 5.8 wt. %, or not greater than about 5.7 wt. %, or not greater than about 5.6 wt. %.

In some embodiments, the Mg content of the weld filler alloy composition may be in the range of from about 5.6 wt. % to about 7.8 wt. %, or from about 5.6 wt. % to about 7.6 wt. %, or from about 5.6 wt. % to about 7.4 wt. %, or from about 5.6 wt. % to about 7.2 wt. %, or from about 5.6 wt. % to about 7.0 wt. %, or from about 5.6 wt. % to about 6.8 wt. %, or from about 5.6 wt. % to about 6.6 wt. %, or from about 5.6 wt. % to about 6.4 wt. %, or from about 5.6 wt. % to about 6.2 wt. %, or from about 5.6 wt. % to about 6.0 wt. %, or from about 5.6 wt. % to about 5.9 wt. %, or from about 5.6 wt. % to about 5.8 wt. %, or from about 5.7 wt. % to about 6.0 wt. %, or from about 5.7 wt. % to about 5.9 wt. %, or from about 5.8 wt. % to about 6.0 wt. %, or from about 5.9 wt. % to about 6.0 wt. %, or from about 5.8 wt. % to about 5.9 wt. %, or from about 5.7 wt. % to about 6.1 wt. %.

In some embodiments, the Zn content of the weld filler alloy composition may be at least about 0.05 wt. %, or at least about 0.1 wt. %, or at least about 0.2 wt. %, or at least about 0.4 wt. %, or at least about 0.6 wt. %, or at least about 0.8 wt. %, or at least about 1.0 wt. %, or at least about 1.2 wt. %, or at least about 1.4 wt. %, or at least about 1.6 wt. %, or at least about 1.8 wt. %, or at least about 2.0 wt. %, or at least about 2.2 wt. %, or at least about 2.4 wt. %, or at least about 2.6 wt. %, or at least about 2.8 wt. %, or at least about 3.0 wt. %, or at least about 3.2 wt. %, or at least about 3.4 wt. %, or at least about 3.5 wt. %.

In some embodiments, the Zn content of the weld filler alloy composition may be not greater than about 3.5 wt. %, or not greater than about 3.4 wt. %, or not greater than about 3.2 wt. %, or not greater than about 3.0 wt. %, or not greater than about 2.8 wt. %, or not greater than about 2.6 wt. %, or not greater than about 2.4 wt. %, or not greater than about 2.2 wt. %, or not greater than about 2.0 wt. %, or not greater than about 1.8 wt. %, or not greater than about 1.6 wt. %, or not greater than about 1.4 wt. %, or not greater than about 1.2 wt. %, or not greater than about 1.0 wt. %, or not greater than about 0.8 wt. %, or not greater than about 0.6 wt. %, or not greater than about 0.4 wt. %, or not greater than about 0.2 wt. %, or not greater than about 0.1 wt. %, or not greater than about 0.05 wt. %.

In some embodiments, the Zn content of the weld filler alloy composition may be in the range of from about 0.5 wt. % to about 3.5 wt. %, or from about 0.5 wt. % to about 3.0 wt. %, or from about 1.0 wt. % to about 3.0 wt. %, or from about 1.5 wt. % to about 3.0 wt. %, or from about 1.5 wt. % to about 2.5 wt. %, or from about 2.0 wt. % to about 2.5 wt. %, or from about 1.7 wt. % to about 2.3 wt. %, or from about 1.8 wt. % to about 2.2 wt. %, or from about 1.9 wt. % to about 2.1 wt. %.

In one embodiment, the present disclosure provides a weld filler alloy comprising from about 5.6 wt. % Mg to about 8 wt. % Mg, from about 0.05 wt. % Zr to about 0.25 wt. % Zr, and a grain refiner, where the grain refiner includes at least one of titanium boride, titanium carbide, hafnium, scandium or mixtures thereof, and balance aluminum, incidental elements and impurities. In one embodiment, the present disclosure provides a weld filler alloy comprising from about 5.6 wt. % Mg to about 8 wt. % Mg, from about 0.05 wt. % Zr to about 0.25 wt. % Zr, from about 0.01 wt. % Ti to about 0.09 wt. % Ti, from about 0.003 wt. % B to about 0.03 wt. % B, and the balance aluminum, incidental elements and impurities. In one embodiment, the present disclosure provides a weld filler alloy comprising from about 5.6 wt. % Mg to about 8 wt. % Mg, from about 0.05 wt. % Zn to about 3.5 wt. % Zn, from about 0.05 wt. % Zr to about 0.25 wt. % Zr, and a grain refiner with the balance aluminum, incidental elements and impurities, wherein the grain refiner is TiB, TiB₂, titanium carbide, hafnium, scandium, other lanthanide elements or mixtures thereof. In one embodiment, the present disclosure provides a weld filler alloy comprising from about 5.6 wt. % Mg to about 8 wt. % Mg, from about 0.05 wt. % Zn to about 3.5 wt. % Zn, from about 0.05 wt. % Zr to about 0.25 wt. % Zr, from about 0.01 wt. % Ti to about 0.09 wt. % Ti, from about 0.003 wt. % B to about 0.03 wt. % B, and the balance aluminum, incidental elements and impurities. In some embodiments, the weld filler alloy is provided in the form of a weld wire or welding rod.

One of the factors for determining the degree of hot cracking is the grain size of the base metal adjoining the welds in the fusion zone and the heat affected zone.

The term “fusion zone” means the region between the weld filler alloy and the base metal at which the weld filler alloy starts to solidify off the epitaxy of the base metal (e.g., the grains or dendrites at which solidification of the weld starts by providing the surface energy for heterogeneous nucleation of the first dendrites of the solidifying weld).

The term “heat affected zone” (HAZ) means the area in the base metal located between the fusion zone and the un-affected base metal. The heat affected zones (HAZs) are the areas in the base metals which are affected by the heat used for welding the base metal parts together.

In one embodiment, the larger the grains are in these regions (e.g., HAZ portion adjacent to fusion zone), the more likely hot cracking is to occur. This is because larger grains form more continuous grain boundaries along which low melting eutectics can accumulate and form nearly continuous partially molten films, which can result in a higher propensity to tear and open up in the form of hot cracks under stress. In other words, it may be necessary to minimize (or eliminate in some instances) the grain growth at the HAZs and their adjoining fusion zones. Doing so may eliminate the presence of nearly continuous and connected grain boundaries along which the partially molten films of low melting eutectics can form and tear open into hot cracks.

For example, during fusion welding of an AA 7085 aluminum alloy part, the grains in the HAZ adjoining the welds tend to grow and form microstructures which are more conducive to hot cracking. In these instances, smaller grains may be needed to reduce or prevent hot cracking, which may reduce tearing since partially molten films formed along grain boundaries are not as continuous and connected as larger grains.

In one embodiment, the Al—Mg and Al—Mg—Zn weld filler alloys disclosed herein may produce small grain sizes and substantially minimize grain growth in the HAZs next to the fusion zone, which may lessen the formation of hot cracking.

In one embodiment, it is has been found that in order to prevent cracking of the base metal or weld, the solidus temperatures of the weld filler alloy and the various dilution of the base metal into the weld need to be lower than the solidus temperatures of the base metal. This means that in the beginning as a weld is forming, the composition of the weld consists mostly of weld filler alloy. As the weld formation progresses, more base metal material may be diluted into the weld. In other words, the weld may include higher and higher amounts of the base metal material mixed with the weld filler alloy. These portions of the weld with different dilution ratios (e.g., different mixture of base metal and weld filler alloy) may follow different solidus temperature paths (e.g., different solidification paths) than the weld filler alloy and/or the base metal. However, to minimize cracking, the solidus temperatures of the various dilution ratios of the base metal into the weld still need to be lower than the solidus temperatures of the base metal across substantially all solid/liquid fractions. This will ensure that the base metal solidifies before the weld filler alloy and also the various dilution ratios thereby reducing the possibility of tearing and cracking within the weld.

As used herein, “solidus temperature” is the temperature at which a given substance solidifies and/or crystallizes. In some instances, solidus temperature means the temperature at which an alloy starts to melt upon heating and completes its solidification upon cooling from a melt. A lower solidus temperature means that at any given time and at a fixed temperature, the amount of solidification in a base metal (e.g., 2xxx, 5xxx, 6xxx or 7xxx series aluminum alloy products/segments) will be higher than the amount of solidification in a weld filler alloy (e.g., Al—Mg or Al—Mg—Zn). This means that the partially molten base metal will solidify before the weldment, and be stronger and less prone to cracking.

In one embodiment, at various solid/liquid fractions, with varying percentage dilution of a 7xxx series aluminum alloy base metal in a weldment, the solidus temperature of the weldment, comprising mostly of Al—Mg or Al—Mg—Zn weld filler alloy, may be lower than the solidus temperature of the 7xxx series aluminum alloy base metal. In some embodiments, similar trends may be observed for 2xxx, 5xxx and 6xxx series aluminum alloy base metals.

As used herein, “solid/liquid fraction” means the solid fraction of a weld (e.g., molten metal) on a mass basis. For example, as a weld is in the process of solidifying, the solid/liquid fraction gradually increases from a value of 0.00 (e.g., weld is mostly molten metal) to 1.00 (e.g., weld is mostly solid). In some instances, a solid/liquid fraction of 0.20 means that the weld is about 20% solid with about 80% molten metal (e.g., liquid), and a solid/liquid fraction of 0.60 means that the weld is about 60% solid and about 40% molten metal (e.g., liquid).

In some embodiments, the solidus temperature of the weld filler alloys may be at least about 1° C. lower than the base metals, or at least about 2° C. lower, or at least 3° C. lower, or at least about 4° C. lower, or at least about 5° C. lower, or at least about 6° C. lower, or at least about 7° C. lower, or at least about 8° C. lower, or at least about 9° C. lower, or at least about 10° C. lower. The solidus temperature trend (e.g., weld filler alloys being lower than the base metals) may be true across all solid/liquid fractions, or at least across a majority of solid/liquid fractions. In some embodiments, the weldment containing the Al—Mg or Al—Mg—Zn weld filler alloy may solidify after the partially molten base metal aluminum alloy products/segments thereby leading to a stronger weldment that is less prone to cracking. This will become more apparent in subsequent figures and discussion.

The weld filler alloy compositions disclosed herein for melting and mixing with the base metals (e.g., 2xxx, 5xxx, 6xxx and 7xxx series) are able to provide weld deposits whose solidus temperatures are lower than the solidus temperatures of the base metals being joined and/or repaired. This allows the partially molten base metals to solidify in the fusion zone and adjoining HAZs thereby substantially preventing hot cracking and liquation cracking in these regions of the weldments. In some embodiments, the weld filler alloy compositions may include TiB₂ and/or Zr as grain refiners to minimize the size of the dendrites and spacing between them in the weld. The addition of grain refiners to the Al—Mg or Al—Mg—Zn weld filler alloy may help minimize the size of dendrites formed and spacing between the dendrites thereby minimizing the propensity for liquation cracking in the welds and regions next to the fusion zones. One of the weld filler alloys includes Zn for improved resistance to sensitization, which in turn reduces propensity to stress corrosion cracking of the weld deposits and further suppresses the solidus temperatures of the solidifying welds, at different solid to liquid fractions. In one embodiment, the weld filler alloy has a weight ratio of 3:1 of titanium to boron.

In one embodiment, to repair a defective part with a weld filler alloy, the weld filler alloy may be provided, proximal to the defective area of the part. The defective part and the weld filler alloy may subsequently be melted and/or fused together into a weldment. The weld filler alloy may be in the form of a weld wire or a weld rod, among others. In general, the weld filler alloy has a solidus temperature that is lower than the solidus temperature of the base metal and which upon fusion welding and dilution with the base metal being repaired results in the weldment whose solidus temperature is lower than the solidus temperatures of the base metal being welded, at any solid/liquid fraction during the solidification of the weldment.

In some embodiments, the weld filler alloy compositions disclosed herein may weld the following combinations of base metals including, but are not limited to, AA 7085 to AA 7085, AA 7085 to AA 6013, AA 7085 to AA 5083, AA 7085 to AA 2099, AA 7085 to modified AA 7085, modified AA 7085 to modified AA 7085, modified AA 7085 to AA 6013, modified AA 7085 to AA 5083, modified AA 7085 to AA 2099, AA 6013 to AA 6013, AA 6013 to AA 5083, AA 6013 to AA 2099, AA 5083 to AA 5083, AA 5083 to AA 2099, and AA 2099 to AA 2099.

Some embodiments of AA 7085 and modified AA 7085 base metals capable of being joined or welded in accordance with the instant disclosure are disclosed, in Table 2 below.

TABLE 2
Embodiments of AA 7085 and modified AA 7085 base metals

| | | | Modified AA | Modified AA |
|---|---|---|---|---|
| | AA 7085-1 | AA 7085-2 | 7085-1 | 7085-2 |
| Cu | 1.3-2.0 | 1.6 | 1.3-2.0 | 1.6 |
| Mg | 1.2-1.8 | 1.5 | 1.2-1.8 | 1.5 |
| Zn | 7-8 | 7.5 | 7-8 | 7.5 |
| Si | <0.06 | <0.06 | <0.06 | <0.06 |
| Fe | <0.08 | <0.08 | <0.08 | <0.08 |
| Zr | 0.05-0.2 | 0.11 | 0.05-0.2 | 0.11 |
| Ca | <0.0012 | <0.0012 | <0.0012 | <0.0012 |
| Ti | 0.03-0.15 | 0.06 | 0.03-0.15 | 0.06 |
| B | — | — | 0.01-0.05 | 0.02 |
| Sc | — | — | 0.1-0.3 | 0.2 |
| Al | Balance | Balance | Balance | Balance |

In one embodiment, AA 7085-1 base metal includes from about 1.3 wt. % Cu to about 2.0 wt. % Cu, from about 1.2 wt. % Mg to about 1.8 wt. % Mg, from about 7 wt. % Zn to about 8 wt. % Zn, the balance essentially aluminum, incidental elements and impurities. In one embodiment, the AA 7085-2 base metal includes about 1.6 wt. % Cu, about 1.5 wt. % Mg, about 7.5 wt. % Zn, the balance essentially aluminum, incidental elements and impurities.

In one embodiment, modified AA 7085-1 and modified. AA 7085-2 base metals include similar compositions as those of AA 7085-1 and AA 7085-2, respectively, with variations in incidental elements and impurities.

The alloys of the present disclosure generally include the stated alloying ingredients, the balance being aluminum, optional grain structure control elements, optional incidental elements and impurities.

As used herein, “grain structure control element” means elements or compounds that are deliberate alloying additions with the goal of forming second phase particles, usually in the solid state, to control solid state grain structure changes during thermal processes, such as recovery and recrystallization. Examples of grain structure control elements include Zr, Sc, V, Cr, Mn, and Hf, to name a few.

The amount of grain structure control material utilized in an alloy is generally dependent on the type of material utilized for grain structure control and the alloy production process. When zirconium (Zr) is included in the alloy, it may be included in an amount up to about 0.4 wt. %, or up to about 0.3 wt. %, or up to about 0.2 wt. %, or up to about 0.1 wt. %. In some embodiments, Zr is included in the alloy in an amount of from about 0.05 wt. % to about 0.15 wt. %. In other embodiments, Zr is included in the alloy in an amount of from about 0.09 wt. % to about 0.11 wt. %. Scandium (Sc), vanadium (V), chromium (Cr), manganese (Mn) and/or hafnium (Hf) may be included in the alloy as a substitute (in whole or in part) for Zr, and thus may be included in the alloy in the same or similar amounts as Zr. In some embodiments, no grain structure control elements are used, such as when there is no inherent need to control, for example, recrystallization. For example, manganese is not added or included in the alloy.

As used herein, “incidental elements” means those elements or materials that may optionally be added to the alloy to assist in the production of the alloy. Examples of incidental elements include casting aids, such as grain refiners and deoxidizers.

Grain refiners are inoculants or nuclei to seed new grains during solidification of the alloy. An example of a grain refiner is a ⅜ inch rod comprising 96% aluminum, 3% titanium (Ti) and 1% boron (B), where virtually all boron is present as finely dispersed TiB₂ particles, During casting, the grain refining rod is fed in-line into the molten alloy flowing into the casting pit at a controlled rate. The amount of grain refiner included in the alloy is generally dependent on the type of material utilized for grain refining and the alloy production process. Examples of grain refiners include Ti combined with boron (e.g., TiB₂) or carbon (TiC), although other grain refiners, such as Al—Ti master alloys may be utilized. In some embodiments, grain refiners used in aluminum base metals or weld filler alloys may include, but are not limited to, Hf, Sc, Zr, Y, other lanthanide elements or mixtures thereof. The term “lanthanide elements” means any of the chemically related elements with atomic numbers 57 through 71 (i.e., lanthanum, cerium, praseodymium, neodymium, promethium, samarium, europium, gadolinium, terbium, dysprosium, holmium, erbium, thulium, ytterbium, and lutetium).

Generally, grain refiners (e.g., carbon or boron) may be added to the alloy in an amount of ranging from 0.0003 wt. % to 0.03 wt. %, depending on the desired as-cast grain size. In addition, Ti may be separately added to the alloy in an amount up to 0.03 wt. %, or up to about 0.06 wt. %, to increase the effectiveness of grain refiner. When Ti is included in the alloy, it is generally present in an amount of up to about 0.10 or 0.20 wt. %, or from about 0.01 wt. % to about 0.09 wt. %. When B is included in the alloy, it is generally in an amount of up to about 0.02 wt. %, or from about 0.01 wt. % to about 0.09 wt. %, or from about 0.003 wt. % to about 0.03 wt. %. In some embodiments, the ratio of Ti to B may be about 3 to 1.

Some alloying elements, generally referred to herein as deoxidizers (irrespective of whether the actually deoxidize), may be added to the alloy during casting to reduce or restrict (and in some instances eliminate) cracking of the ingot resulting from, for example, oxide fold, pit and oxide patches. Examples of deoxidizers include Ca, Sr, and Be. When calcium (Ca) is included in the alloy, it is generally present in an amount of up to about 0.05 wt. %, or up to about 0.03 wt. %, or not greater than about 0.0012 wt. %. In some embodiments, Ca is included in the alloy in an amount of 0.001-0.03 wt. % or about 0.05 wt. %, such as from about 0.001 wt. % to about 0.008 wt. % (or 10 to 80 ppm). Strontium (Sr) may be included in the alloy as a substitute for Ca (in whole or in part), and thus may be included in the alloy in the same or similar amounts as Ca. Traditionally, beryllium (Be) additions have helped to reduce the tendency of ingot cracking, though for environmental, health and safety reasons, some embodiments of the alloy are substantially Be-free. When Be is included in the alloy, it is generally present in an amount of up to about 20 ppm.

Incidental elements may be present in minor amounts, or may be present in significant amounts, and may add desirable or other characteristics on their own without departing from the alloy described herein, so long as the alloy retains the desirable characteristics described herein. It is to be understood, however, that the scope of this disclosure should not/cannot be avoided through the mere addition of an element or elements in quantities that would not otherwise impact on the combinations of properties desired and attained herein.

As used herein, impurities are those materials that may be present in the alloy in minor amounts due to, for example, the inherent properties of aluminum and/or leaching from contact with manufacturing equipment. Iron (Fe) and silicon (Si) are examples of impurities generally present in aluminum alloys. In some embodiments, manganese (Mn) may be an impurity. The Fe content of the alloy should generally not exceed about 0.25 wt. %. In some embodiments, the Fe content of the alloy is not greater than about 0.15 wt. %, or not greater than about 0.10 wt. %, or not greater than about 0.08 wt. %, or not greater than about 0.05 or 0.04 wt. %. Likewise, the Si content of the alloy should generally not exceed about 0.25 wt. %, and is generally less than the Fe content. In some embodiments, the Si content of the alloy is not greater than about 0.15 wt. %, or not greater than about 0.12 wt. %, or not greater than about 0.10 wt. %, or not greater than about 0.06 wt. %, or not greater than about 0.03 or 0.02 wt. %.

In one embodiment, the weld filler alloy composition includes not greater than about 0.05 wt. % Mn as impurity. In some embodiments, the weld filler alloy composition includes impurities of less than about 0.4 wt. % Mn, or not greater than about 0.35 wt. % Mn, or not greater than about 0.3 wt. % Mn, or not greater than about 0.25 wt. % Mn, or not greater than about 0.20 wt. % Mn, or not greater than about 0.15 wt. % Mn, or not greater than about 0.10 wt. % Mn. In one embodiment, the weld filler alloy composition disclosed herein is substantially free of Mn. In some embodiments, the weld filler alloy composition disclosed herein need not include any amount of Mn or include minimal amount of Mn that is present as an impurity.

In some instances, manganese may be a reproductive toxin and may cause neurological disorders (e.g., manganism). In other instances, manganese poisoning may be associated with secondary Parkinson's disease. Further, some studies have demonstrated neurological changes (e.g., poor motor function) with exposure to low levels of manganese.

In some environments, occupational exposure limits (OELs) to manganese may be not greater than about 0.05 mg/m³ total dust level over an 8-hour time weighted average (TWA), or not greater than about 0.02 mg/m³ respirable dust level over an 8-hour TWA. In other environments, OELs may be not greater than about 0.2 mg/m³ total dust level over an 8-hour time weighted average (TWA), or not greater than about 0.2 mg/m³ inhalable dust level over an 8-hour TWA, or not greater than about 0.02 mg/m³ respirable dust level over an 8-hour TWA. In one instance, the manganese exposure may have a ceiling of not greater than about 5 mg/m³.

In some instances, welding fumes may arise from a weld filler wire. These fumes may include magnesium in addition to oxides of manganese. The OELs for the oxides of manganese may be not greater than about 10 mg/m³ total inhalable dust level over an 8-hour TWA, or not greater than about 15 mg/m³ total inhalable dust level over an 8-hour TWA. In some cases, exposure to magnesium oxide fumes may cause metal fume fever, which is a fever-like condition that may be reversed upon removal from such exposure.

In one embodiment, a method of welding a first aluminum product to a second aluminum product is disclosed. In this embodiment, each of the first aluminum product and the second aluminum product is at least one of 2xxx, 5xxx, 6xxx and 7xxx series aluminum alloy. In one instance, the two aluminum products may be placed proximal to each other to facilitate the welding process. In one method, the welding step may include welding the 2xxx, 5xxx, 6xxx and 7xxx series aluminum alloy products to each other (e.g., 6xxx to 5xxx, 2xxx to 7xxx) or to itself (e.g., 7xxx to 7xxx, 6xxx to 6xxx) using an Al—Mg weld filler alloy or an Al—Mg—Zn weld filler alloy to produce a welded aluminum alloy product. In some embodiments, the weld filler alloy utilized may include any of the compositions disclosed herein.

In some embodiments, welding means to join at least two aluminum parts together by at least one of heating, melting, fusing, or combinations thereof, with the assistance of a weld filler alloy. Examples of welding processes include gas tungsten arc welding (GTAW), shielded metal arc welding (SMAW), gas metal arc welding (GMAW), plasma arc welding (PAW), plasma welding (PW), electron beam welding (EBW), and laser beam welding (LBW), to name a few. Suitable types of welding joints for welding base metals with the weld filler alloys include but are not limited to, lap-fillet, square-type butt, vee-type butt, and tee-fillet, among others. In one embodiment, 2xxx, 5xxx, 6xxx and 7xxx series aluminum alloy products may be welded together, whether to each other or to itself, by patch welding. Patch welding is welding in a localized area for the purpose of repair of a damages area (e.g., crack(s), worn down areas), and which has the appearance of a patch. In some embodiments, welding involves melting and/or fusing the two aluminum products and the weld filler alloy to form a weldment. In some embodiments, the weld filler alloy utilized may include any of the compositions disclosed herein.

In some instances, in order to join two aluminum base metal segments together, the two aluminum base metal segments may be placed proximal to each other. Subsequently, welding of the two aluminum base metal segments and the weld filler alloy may be carried out by melting and/or fusing the base metal segments and the weld filler alloy into a weldment.

In one embodiment, both the Al—Mg and the Al—Mg—Zn weld filler alloys have lower solidus temperatures than the 2xxx, 5xxx, 6xxx and 7xxx aluminum alloy products. In one embodiment, a method includes welding at least one 2xxx, 5xxx, 6xxx or 7xxx aluminum alloy product to another 2xxx, 5xxx, 6xxx or 7xxx aluminum alloy product with an Al—Mg or Al—Mg—Zn weld filler alloy, where the 2xxx, 5xxx, 6xxx and 7xxx aluminum alloy products have higher solidus temperatures than the Al—Mg or Al—Mg—Zn weld filler alloys.

In one embodiment, segments of 2xxx, 5xxx, 6xxx or 7xxx series aluminum alloys may be welded to each other or to itself. For example, a first aluminum alloy segment may be welded or joined to a second aluminum alloy segment via a weldment, where the weldment includes a weld filler alloy, and where each of the first aluminum alloy segment and the second aluminum alloy segment is at least one of 2xxx, 5xxx, 6xxx and 7xxx series aluminum alloy. In some embodiments, the weld filler alloy includes the weld filler alloy compositions disclosed herein. Furthermore, the segments may be welded and/or repaired in accordance with the techniques and methods disclosed herein.

In some embodiments, the 2xxx, 5xxx, 6xxx or 7xxx series aluminum alloy products may be welded and/or repaired with the weld filler alloys disclosed herein. In these embodiments, the welded and/or repaired aluminum alloy products may have improved conditions due to a welding and/or repairing step. For example, a 2xxx, 5xxx, 6xxx or 7xxx series aluminum alloy mold plate product may be welded and/or repaired by welding an Al—Mg or Al—Mg—Zn weld filler alloy to the mold plate product. Since the product is welded and/or repaired, it may realize an improved condition, and thus, in some instances, may be restored so that it may perform at least one of its original intended functions.

In one embodiment, the welded and/or repaired 2xxx, 5xxx, 6xxx or 7xxx series aluminum alloy product comprises an original portion, a repaired portion, or an additional portion. After welding, the welded and/or repaired portion may have a substantially similar appearance as the original portion. In one embodiment, the appearance relates to color. In one embodiment, the welded and/or repaired portion has substantially the same color as the original portion. A welded and/or repaired portion is substantially the same color when, as viewed with the naked eye, it appears to have the same color as that of the original portion of the product, when viewed with 20/20 vision and lighting conditions comparable to normal, sunny outdoor lighting. In one embodiment, the welded and/or repaired portion has substantially the same texture as the original portion. A welded and/or repaired portion has substantially the same texture as the original portion when the grain size and orientation of the welded and/or repaired portion closely replicates that of the original grain portion (e.g., as traced to a master plaque).

An original portion of the 2xxx, 5xxx, 6xxx or 7xxx series aluminum alloy product is a portion of a product that was a part of the product before a welding and/or repairing step. A welded and/or repaired portion of the 2xxx, 5xxx, 6xxx or 7xxx series aluminum alloy product is a portion of a product that was not a part of the product before a welding and/or repairing step, but constitutes a part of the product (e.g., an integral part of the product) after the welding and/or repairing step (e.g., a weld-deposit or weldment). For example, prior to a welding and/or repairing step, a mold plate may comprise an original portion and one or more defects. After a repairing step, a mold plate may comprise an original portion and at least one repaired portion, which portion may be integral with the product. After a welding step, a mold plate may comprise an original portion of one aluminum alloy and at least an additional portion which contains the same aluminum alloy or a different aluminum alloy. An integral portion means that the welded and/or repaired area has become integrated with the 2xxx, 5xxx, 6xxx or 7xxx series aluminum alloy product. In some embodiments, the integrated portion at least partially assists in restoring the appearance (e.g., cracking, color match, texture) and/or functionality (e.g., shock resistance, wear resistance) of the 2xxx, 5xxx, 6xxx or 7xxx series aluminum alloy product that is welded and/or repaired.

In one embodiment, after the welding, the weldments of the 2xxx, 5xxx, 6xxx or 7xxx series aluminum alloy products/segments are substantially free of cracks. A weldment is substantially free of cracks when it contains no greater than the amount of cracks a similarly welded and/or repaired weldment produced from the AA 5083, AA 5183, AA 5356, AA 5556 or AA 4145 weld filler alloys contain. In one embodiment, the welded portion and/or repaired product contains at least about 10% fewer cracks than a similarly welded and/or repaired portion produced from AA 5083, AA 5183, AA 5356, AA 5556 or AA 4145 weld filler alloys. In some embodiments, the welded and/or repaired portion may contain at least about 15% fewer, or at least about 20% fewer, or at least about 25% fewer, or at least about 30% fewer, or at least about 35% fewer, or at least about 40% fewer, or at least about 45% fewer, or at least about 50% fewer, or at least about 60% fewer, or at least about 70% fewer cracks than a similarly welded and/or repaired portion produced from AA 5083, AA 5183, AA 5356, AA 5556 or AA 4145 weld filler alloys, among others.

In some embodiments, the welded and/or repaired portion may contain crack lengths that are not greater than about 0.01 mm, or not greater than about 0.02 mm, or not greater than about 0.03 mm, or not greater than about 0.04 mm, or not greater than about 0.05 mm, or not greater than about 0.06 mm, or not greater than about 0.07 mm, or not greater than about 0.08 mm, or not greater than about 0.09 mm, or not greater than about 0.1 mm, or not greater than about 0.12 mm, or not greater than about 0.15 mm, or not greater than about 0.2 mm, or not greater than about 0.25 mm, or not greater than about 0.3 mm, or not greater than about 0.4 mm, or not greater than about 0.5 mm, or not greater than about 1 mm, or not greater than about 2 mm, or not greater than about 5 mm, or not greater than about 10 mm, than a similarly welded and/or repaired portion produced from AA 5083, AA 5183, AA 5356, AA 5556 or AA 4145 weld filler alloys, among others. A similarly welded and/or repaired portion means that similar welding procedures are used to prepare a weldment, excluding the choice of the type of weld filler alloy. A crack is an internal or external surface opening and/or discontinuity. A crack generally affects the performance (e.g., shock resistance, wear resistance) of the original 2xxx, 5xxx, 6xxx or 7xxx series aluminum alloy products/segments.

In one embodiment, the welded portion and/or repaired product/segments is at least as durable as a similarly welded and/or repaired portion produced from AA 5083, AA 5183, AA 5356, AA 5556 or AA 4145 weld filler alloys, among others. For example, welded and/or repaired 2xxx, 5xxx, 6xxx or 7xxx series aluminum alloy products/segments using the Al—Mg or Al—Mg—Zn weld filler alloys disclosed herein may be at least as durable as (or more durable than) the same aluminum alloy products/segments welded and/or repaired using AA 5083, AA 5183, AA 5356, AA 5556 or AA 4145 weld filler alloys, among others. In some embodiments, the welded and/or repaired aluminum alloy products/segments using the Al—Mg or Al—Mg—Zn weld filler alloys may achieve at least the same amount of acceptable injection shots (or within acceptable statistical deviation) as that of the same aluminum alloy products/segments welded and/or repaired using AA 5083, AA 5183, AA 5356, AA 5556 or AA 4145 weld filler alloys, among others. Acceptable injection shots are those shots in which the products/segments produce aluminum products having acceptable texture and color match. In one embodiment, the welded portion and/or repaired product is at least twice as durable as a similarly welded and/or repaired portion produced from AA 5083, AA 5183, AA 5356, AA 5556 or AA 4145 weld filler alloys, among others.

In one embodiment, the welded portion and/or repaired product may demonstrate little or reduced (and none in some instances) pitting. Pitting means a discontinuity not greater than about 1 mm in diameter and/or depth. In other embodiments, pitting may not be greater than about 2 mm, or not greater than about 5 mm, or not greater than about 0.5 mm, or not greater than about 0.1 mm. Pitting can result from a poor weld and leave voids that have a detrimental impact on the surface to be textured in the instance of mold plates.

In one embodiment, the welded and/or repaired portion is adherent, Adherent means that the weld-deposit (e.g., weldment), which is used to weld and/or repair the damaged area of the 2xxx, 5xxx, 6xxx or 7xxx series aluminum alloy products/segments, reliably continues to adhere to the welded and/or repaired portion in service (e.g., repeatable injection-molding shots), while continuing to retain/provide at least some of the appearance and/or functional properties discussed herein (e.g., wear resistance, cracking, texture, color match, shock resistance).

In one embodiment, the welded portion and/or repaired product may be wear resistant. Wear resistant means that the hardness of the weld-deposit (e.g., weldment), which is used to weld and/or repair the damaged area of the 2xxx, 5xxx, 6xxx or 7xxx series aluminum alloy products/segments, will provide wear resistance necessary to withstand repeated and numerous injection-molding shots in service. For different injection molding applications (e.g. different polymers), the hardness of this weld-deposit may be chosen so it is compatible with the hardness of the original portion of the 2xxx, 5xxx, 6xxx or 7xxx series aluminum alloy products/segments. In some embodiments, the welded portion, and sometime the whole repaired 2xxx, 5xxx, 6xxx or 7xxx series aluminum alloy products/segments, may be artificially aged (e.g., to an appropriate temper) after the repairing step to facilitate production of a welded and/or repaired portions which has a hardness and/or wear resistance that resembles that of the original portion. In one embodiment, the welded portion and/or repaired product has a hardness that is at least equivalent to that of a welded and/or repaired portion produced from AA 5083, AA 5183, AA 5356, AA 5556 or AA 4145 weld filler alloys, among others.

In one embodiment, the welded portion and/or repaired product may be thermal shock resistant. Thermal shock resistant means that the weld-deposit (e.g., weldment), which is used to weld and/or repair the 2xxx, 5xxx, 6xxx or 7xxx series aluminum alloy products/segments, and the original portion is able to withstand repeated and numerous extreme changes in temperature without cracking and/or to a degree that adversely affects the performance of the weldment.

In one embodiment, the welded portion and/or repaired product may be impact shock resistant. Impact shock resistant means that the weld-deposit (e.g., weldment), which is used to weld and/or repair the 2xxx, 5xxx, 6xxx or 7xxx series aluminum alloy products/segments, and the original portion is able to withstand repeated and numerous mechanical-type impacts without cracking and/or to a degree that adversely affects the performance of the weldment.

As discussed above, the weld filler alloys having solidus temperatures that are higher than the base metal segments at certain solid/liquid fractions may have issues repairing or joining base metal segments because the weld filler alloys in the weld deposits may solidify before the base metal segments thereby leading to cracking within the weld.

In one embodiment, when repairing a base metal plate, the repair can take place by welding the base metal plate via a weld filler alloy to produce a repaired base metal plate. The weld filler alloy can be an Al—Mg alloy or an Al—Mg—Zn alloy. The base metal plate can be any aluminum alloy of the 2xxx, 5xxx, 6xxx or 7xxx series. And the weld filler alloy can have substantially lower solidus temperatures than the base metal plate at all solid/liquid fractions.

In one embodiment, the repaired base metal plate can be textured to produce a first object having substantially similar color match as a second object, wherein the second object is produced from a non-repaired base metal plate. For example, an object includes plastic mold of a toy manufactured from a base metal plate including polypropylene injection molding. In one instance, the color around the weld area is substantially similar such that one cannot tell the difference between an object produced by a repaired base metal plate from another object produced by a non-repaired base metal plate.

In one embodiment, once repaired, the levels of weld discontinuities (e.g., cracks and pores) in the weld-repaired deposits should be acceptable to specific applications and conditions encountered in service. Some of the characteristics include without limitation relatively high abrasion resistance, thermal and mechanical shock resistance, and material strength at elevated temperatures. Other characteristics include overall appearance, color match, pitting, adhesion and hardness. In one instance, the smoothness of the weld-repaired areas allows for ease of blending with adjoining surfaces of the base metal plate.

In some instances, chemical compatibility of the weld-repaired deposits with an aluminum alloy base metal plate may be enhanced after texturing by chemical etching. In one example, texturing is carried out in order to restore a base metal plate to its original texture, or as close to it as possible. The attempt to restore the base metal plate to its original texture may be necessary for control over the surfaces of the injection parts and preventing them from sticking to the base metal plates during injection molding processes and the removal of the parts. In other words, restoring a base metal plate to its original texture or having the fusion welding repair to be as close to the original texture as possible is critical to the object or plastic part produced.

One of the characteristics of judging chemical compatibility is the degree of discoloration imparted to the plastic parts upon their removal from the repaired base metal plate. The discoloration of the parts may be caused by variations in the textured weld-repaired areas (e.g., the way the areas are etched compared to the original aluminum alloy base metal plate), which can lead to visible changes to the way light is reflected and absorbed by the plastic parts and/or actual leaching of aluminum alloy(s) from the weld deposits into the plastic parts. In one embodiment, the weld-repaired area should cause no such discoloration to the production application products or parts.

In addition, the degree of pitting of the weld-repair deposits during the chemical texturing operation, which may increase the degree of sticking of the plastic and adversely affect the ease of removal from the base metal plates and/or appearance of the parts, should be minimized or eliminated.

In one embodiment, the repair technique of a base metal plate with an Al—Mg or Al—Mg—Zn weld filler alloy may include: a) removing an affected (damaged, e.g. cracked, worn out) area on the base metal plate by grinding or machining, b) cleaning this area with a solvent, drying, brushing with a stainless steel brush, solvent cleaning and drying again, c) “building-up” (or restoring) this area to its original shape, by deposition of weld deposits on the top and adjacent to each other using the disclosed Al—Mg or Al—Mg—Zn weld filler alloys with the aid of manual gas tungsten arc welding process, for instance, and d) grinding off the weld deposit so it blends with its adjacent unaffected surfaces of the mold plate.

The quality and characteristics of the areas weld-repaired with the weld filler alloy and/or weld-repair techniques as previously described may be checked against injection molded plastic coupons that are produced of the plastic material of interest (e.g., polyethylene and polypropylene) with the injection molding conditions (e.g., texture of mold, injection mold's temperature and injection molding pressure) and having the desired surface characteristics (appearance, texture, uniformity of color and/or luster). These coupons are used as the “standard” against which the coupons produced after the weld-repair in question. By examining the “standard” coupons and the coupons produced with the repaired weld filler alloy alloys and/or techniques being evaluated and comparing their surface characteristics, it is possible to judge the quality of the experimental coupons. The attributes that are compared include: a) general coupon appearance, b) texture and uniformity across the coupon (e.g., presence of dents), c) uniformity of color (color-match and if there is not a good color-match between the “standard” and sample coupons and/or the surfaces of the sample coupon corresponding to the repaired areas and their adjacent unaffected mold surfaces) or luster, especially between the repaired area and its adjoining unaffected surfaces of the mold plate.

Aluminum Association 7xxx Series Aluminum Alloys

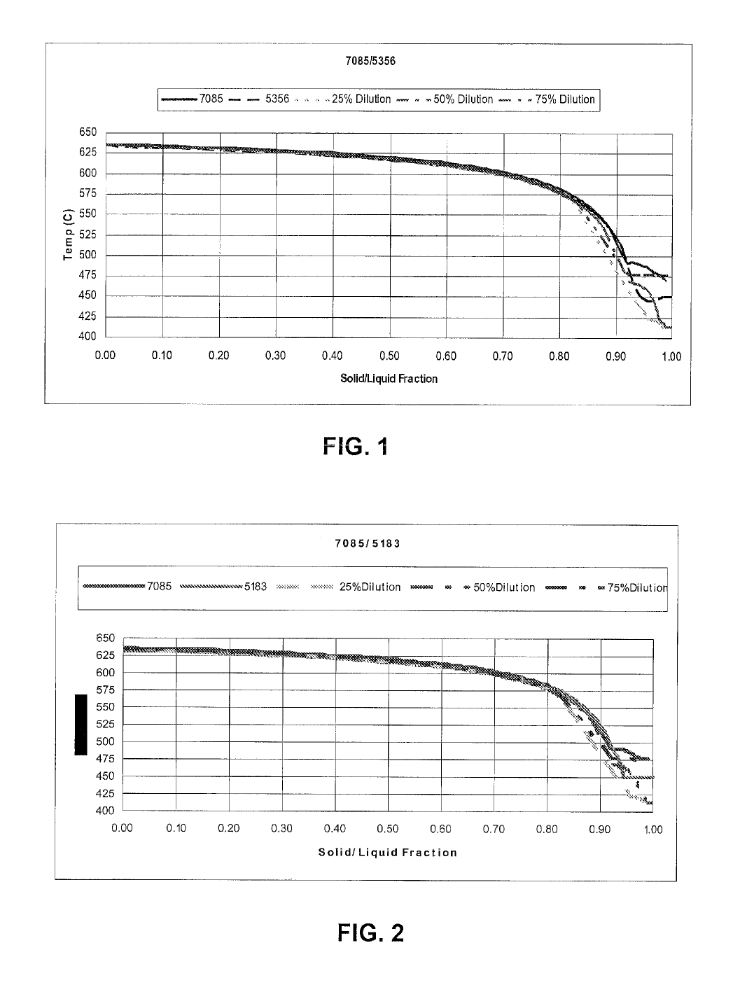

FIG. 1 illustrates a comparison of solidus temperatures between an AA 7085 aluminum alloy base metal and welds produced with an AA 5356 weld filler alloy at different solid/liquid fractions, with varying percentage of dilution of the AA 7085 base metal and the AA 5356 weld filler alloy within a weldment (e.g., weld deposit). For example, a 25% dilution means a weld deposit includes about 25% base metal mixed with about 75% weld filler alloy, a 50% dilution means that half of the weld contains base metal and the other half contains weld filler alloy, and a 75% dilution means that about 75% of the base metal is mixed with about 25% of the weld filler alloy in the weld. The various lines represent the different solidification paths that may be taken by a weld deposit as temperature decreases. For example, the line “7085” is representative of the solidification path of the AA 7085 aluminum alloy base metal, the line “5356” is representative of the solidification path of the AA 5356 weld filler alloy, and the three different dilution ratios are representative, respectively, of the solidification paths of the three different dilution ratios within the weld deposit. In general, as temperature decreases (e.g., solidification and cooling), the solid contents within a weld deposit increases. In other words, as temperature decreases, the solid/liquid fraction generally increases for any given solidification path.

As shown in FIG. 1, at solid/liquid fractions of from about 0.00 to about 0.80, the amount of solidification (e.g., amount of solid contents) within the base metal (e.g., AA 7085) is substantially similar to the amount of solidification within the weld filler alloy (e.g., AA 5356). That is, the two have substantially similar solidification paths. Same may be said for the various dilution ratios (e.g., the amount of solidification of the base metal being substantially similar to that of the various dilution ratios). However, at solid/liquid fractions of from about 0.80 to about 1.00, as the solid contents within a weld deposit continues to increase, the amount of solidification in the weld filler alloy is substantially similar and sometimes exceeds that of the base metal (e.g., intersect/crossover at about 525° C. and a solid/liquid fraction of about 0.90).

For instance, as the solid contents within a weld deposit increase when the weld deposit is cooling from about 625° C. to about 525° C., the amount of solidification in both the base metal and the weld filler alloy is substantially similar as both materials slowly increase from having about 20% solid content at about 625° C., to having about 70% solid content at about 600° C., and eventually to having about 80% solid content at about 575° C. Both materials contain about 90% of solid content (e.g., solid/liquid fraction of about 0.90) at a temperature of about 525° C. Upon further cooling, the amount of solidification in the weld filler alloy may exceed those of the base metal (e.g., at solid/liquid fractions of about 0.90 to about 0.95). This may lead to cracking in the fusion zone as discussed above due to tearing of the weld as more weld filler alloy is solidifying before the base metal.

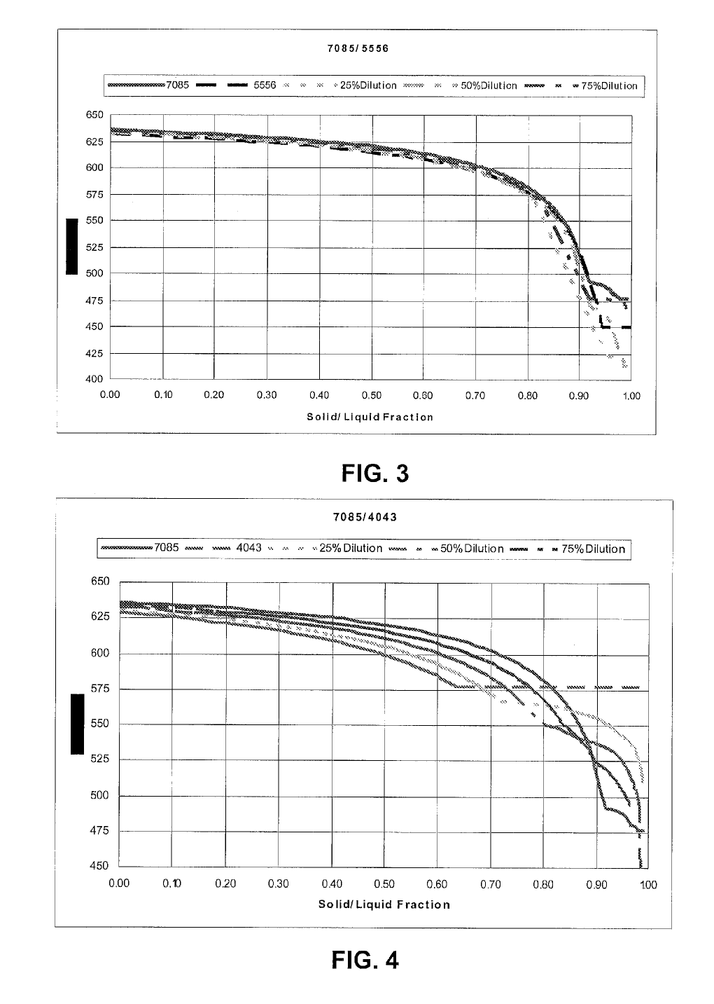

Similar trends may be observed for weld filler alloys AA 5183 (FIG. 2) and AA 5556 (FIG. 3), where the solidus temperatures of the weld filler alloys (e.g., AA 5183 and AA 5556) are generally similar or lower than the AA 7085 aluminum alloy base metal and at various dilution ratios. However, at higher solid/liquid fractions, intersection and/or cross-over of the solidus temperatures may lead to tearing of the welds as the weld filler alloy solidifies before the base metal.

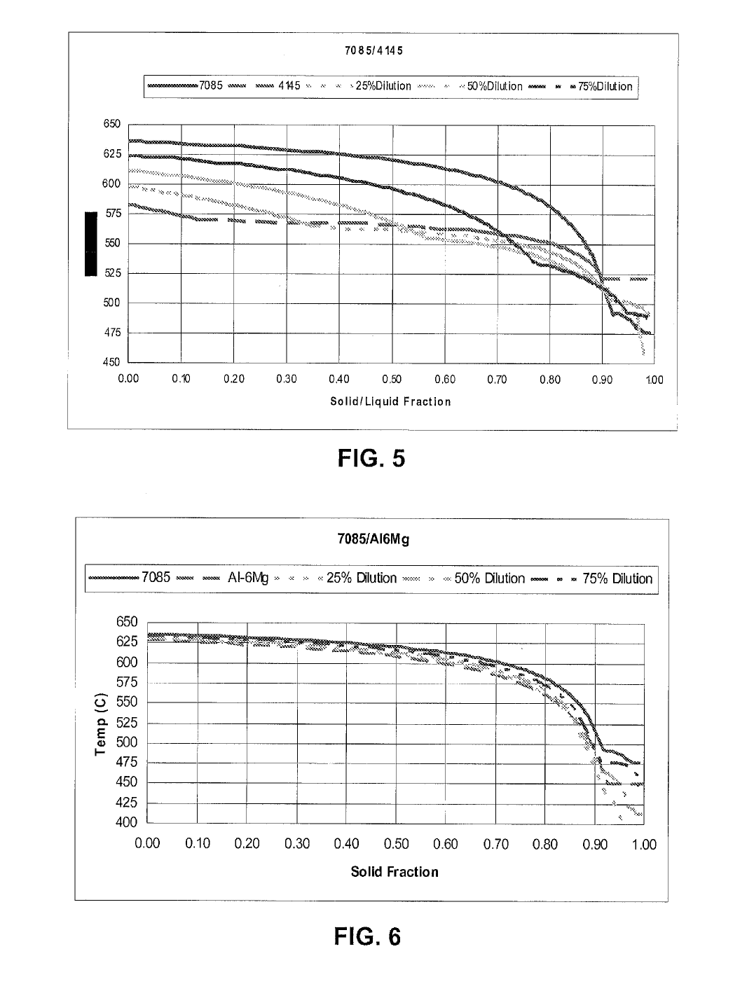

FIGS. 4-5 illustrate solidus temperatures of AA 4043 and AA 4145 weld filler alloys, respectively, versus AA 7085 aluminum alloy base metal at different solid/liquid fractions, with varying percentages of dilution of the AA 7085 base metal and the respective weld filler alloys into the weld-deposit similar to that described above. The effects are more prominent for the 4xxx series aluminum alloys than the 5xxx series aluminum alloys described above.

As shown in FIG. 4, as a weld deposit is solidifying, the AA 4043 weld filler alloy has the tendency to solidify before the AA 7085 base metal, and also the various dilution ratios at relatively high temperatures and low solid/liquid fractions. However, as the weld deposit continues to cool to about 575° C., the AA 4043 weld filler alloy suddenly solidifies from being 60% solid to about 100% solid (e.g., the flat line portion of the 4043 line). It is also at this point and beyond (e.g., temperatures not greater than about 575° C.) that the weld deposit may start to exhibit cracking due to more are more of the AA 4043 weld filler alloy solidifying (e.g., about 100% solid content) before the AA 7085 base metal (e.g., about 80% solid content), and beyond from about 85% solid/liquid fractions where the solidus temperatures of the various dilution ratios exceed that of the AA 7085 base metal.

Likewise, as shown in FIG. 5, the AA 4145 weld filler alloy exhibits similar trends as that of the AA 4043 weld filler alloy where the intersection and cross-over of the AA 4145 weld filler alloy and various dilution ratios with respect to the AA 7085 base metal occur at about 90% solid content and temperatures of not greater than about 525° C.

FIG. 6 illustrates a comparison of solidus temperatures between an AA 7085 aluminum alloy base metal and welds produced with an Al—Mg weld filler alloy according to one embodiment of the present disclosure at different solid/liquid fractions, with varying percentage of dilution of the AA 7085 base metal and the Al—Mg weld filler alloy within a weldment (e.g., weld deposit). In one embodiment, the Al—Mg weld filler alloy contains about 6% Mg and up to about 94% Al.

As shown in FIG. 6, the solid content in the base metal (e.g., AA 7085) is generally higher than the solid content in the weld filler alloy (e.g., Al—Mg) at all solid/liquid fractions. For example, at about 600° C., the Al—Mg weld filler alloy is about 60% solid while the AA 7085 base metal is about 70% solid. Likewise, at about 550° C., the Al—Mg weld filler alloy is about 85% solid while the AA 7085 base metal is about 90% solid. Similarly, at about 500° C., the Al—Mg weld filler alloy is about 90% solid while the AA 7085 base metal is about 92% solid. The solidus temperatures of a weld deposit having an Al—Mg weld filler alloy according to one embodiment of the present disclosure are unexpectedly surprising and consistently lower than those of the AA 7085 base metal, at all solid/liquid fractions. As such, the Al—Mg weld filler alloy according to one embodiment of the present disclosure is capable of producing substantially crack-free welds for joining base metal segments and/or repairing the same.

The same general trend may be said for the various dilution ratios. As shown, the solidus temperatures of the various dilution ratios (e.g., 25%, 50% and 75%) are all lower than the AA 7085 base metal. In these instances, to prevent cracking in the areas adjoining a weld (e.g., HAZ and fusion zone) in the AA 7085 base metal, the Al—Mg weld filler alloy is capable of producing weld deposits with solidus temperatures that are lower than the solidus temperatures of the AA 7085 base metal as various amounts of the AA 7085 base metal are diluted into the weld deposits (e.g., at any base metal/filler alloy dilution ratios). In other words, the Al—Mg weld filler alloy, upon melting and mixing with the AA 7085 base metal, is capable of producing weld deposits with lower likelihood of cracking because a greater percentage of the AA 7085 base metal will solidify before the Al—Mg weld filler alloy at any solid/liquid fractions.

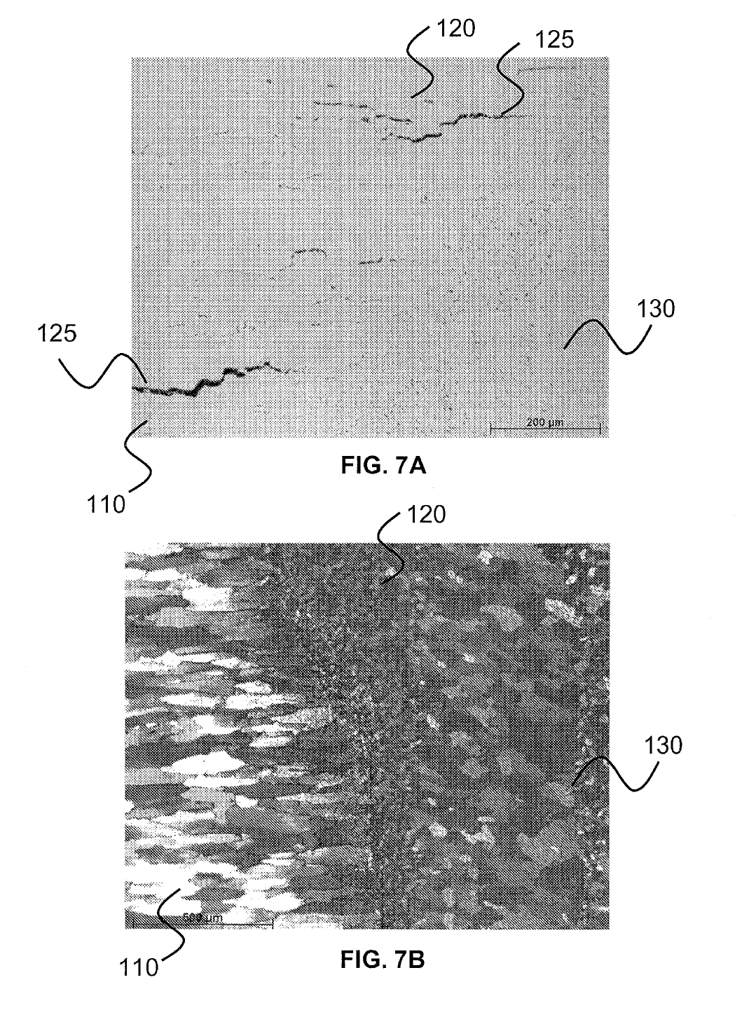

FIGS. 7A and 7B show etched and anodized cross-sectional micrographs, respectively, of a weldment produced with an AA 7085 aluminum alloy base metal with reference numeral 110, an AA 5356 aluminum alloy weld filler wire/weld metal with reference numeral 130, and a fusion zone having a combination of the AA 7085 aluminum alloy base metal and the AA 5356 aluminum alloy weld filler wire/weld metal with reference numeral 120. The cross-sectional views are of a weld produced by gas tungsten arc welding (GTAW) of an end, constrained tee-fillet type joint. FIG. 7A shows a photomicrograph at 200 times magnification of an etched cross-section of a weld produced with the AA 7085 aluminum alloy base metal and the AA 5356 aluminum alloy weld filler wire. FIG. 7B shows a photomicrograph at 500 times magnification of an anodized cross-section of a weld produced with the AA 7085 aluminum alloy base metal and the AA 5356 aluminum alloy weld filler wire. In FIG. 7A, a plurality of hot cracks 125 may be seen at the fusion zone 120 and at the grain boundaries in the AA 7085 aluminum alloy base metal. In FIG. 7B, the grains in the AA 7085 aluminum alloy base metal 110 are much larger than the grains of the fusion zone 120 and the weld metal 130.

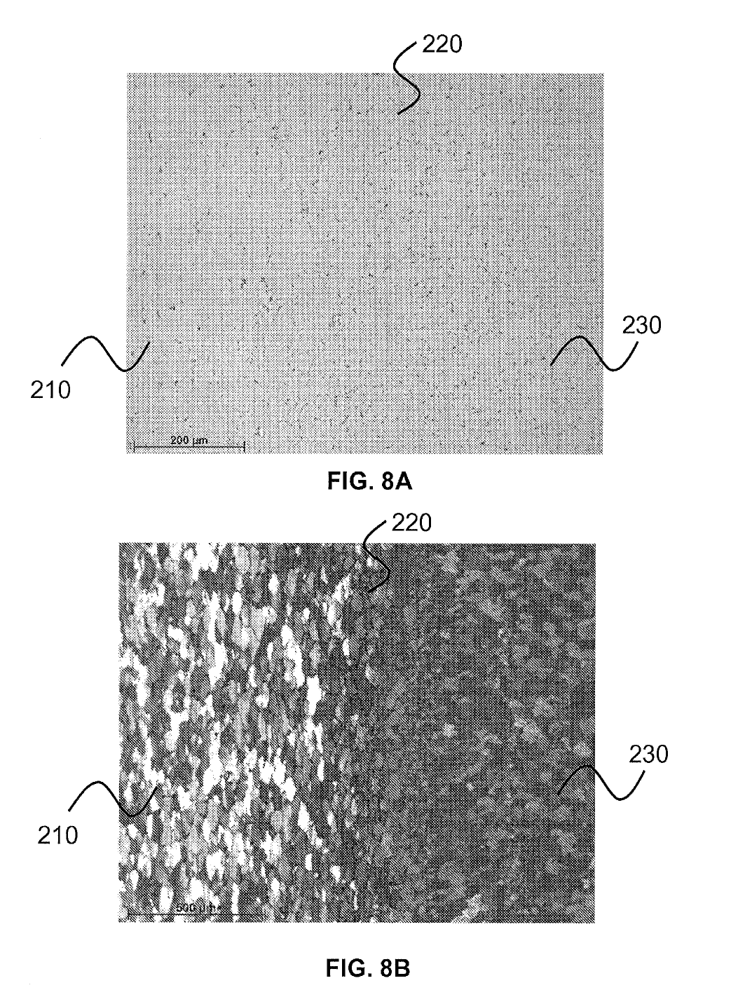

FIGS. 8A and 8B show etched and anodized cross-sectional micrographs, respectively, of a weldment produced with a modified AA 7085 aluminum alloy base metal with reference numeral 210, an Al—Mg weld filler wire/weld metal according to one embodiment of the present disclosure with reference numeral 230, and a fusion zone having a combination of the modified AA 7085 aluminum alloy base metal and the Al—Mg weld filler wire/weld metal with reference numeral 220. The cross-sectional views are of a weld produced by gas tungsten arc welding (GTAW) of an end-constrained tee-fillet type joint. FIG. 8A shows a photomicrograph at 200 times magnification of an etched cross-section of a weld produced with the modified AA 7085 aluminum alloy base metal and the Al—Mg weld filler wire. FIG. 8B shows a photomicrograph at 500 times magnification of an anodized cross-section of a weld produced with the modified 7085 aluminum alloy base metal and the Al—Mg weld filler wire. In FIG. 8A, no hot cracks are visible at the fusion zone 220 or at the grain boundaries in the modified 7085 aluminum alloy base metal 210. In FIG. 8B, the grains in the modified 7085 aluminum alloy base metal 210 are about the same size as the grains in the fusion zone 220 and in the weld metal 230.

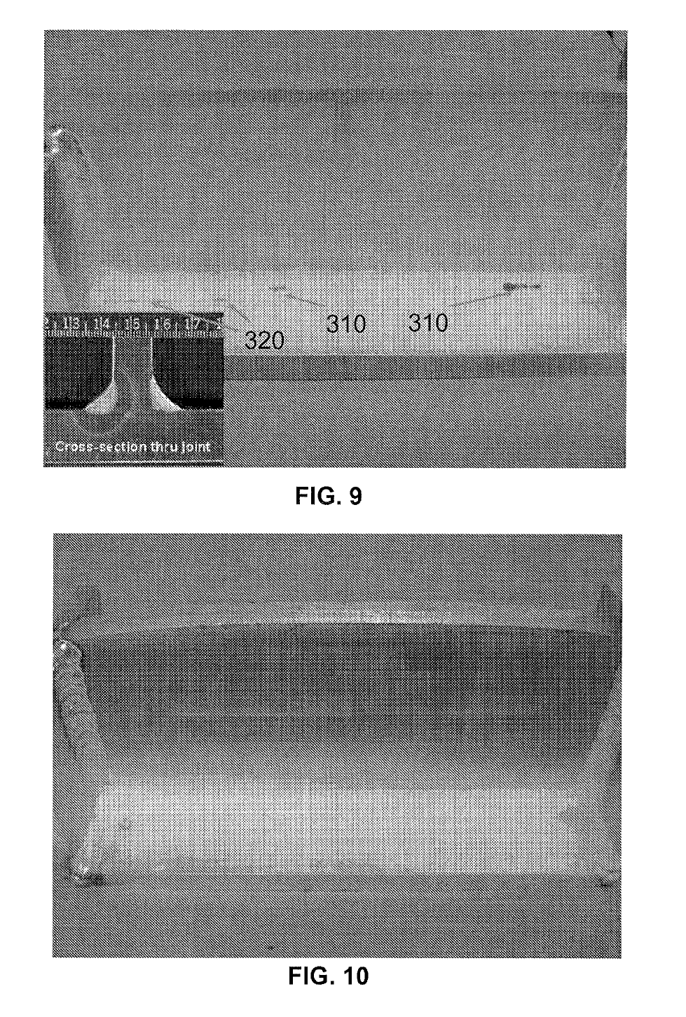

FIG. 9 shows a photograph of a weldment produced by GTAW two half-inch thick AA 7085 aluminum alloy plates with an AA 5356 aluminum weld filler wire through an end-constrained double tee-fillet joint. This weldment is subsequently inspected with a dye penetrant test, which reveals a plurality of open weld cracks 310 and open surface cracks 320 in the AA 7085 aluminum alloy plates and the weldment further confirming the weld cross-sections of FIGS. 7A and 7B.

FIG. 10 shows a photograph of a weldment produced by GTAW two half-inch thick modified AA 7085 aluminum alloy plates with an Al—Mg aluminum weld filler wire according to one embodiment of the present disclosure through an end-constrained double tee-fillet joint. This weldment is subsequently inspected with a dye penetrant test, which reveals substantially no open weld cracks and/or open surface cracks in the modified AA 7085 aluminum alloy plates and the weldment further confirming the weld cross-sections of FIGS. 8A and 8B.

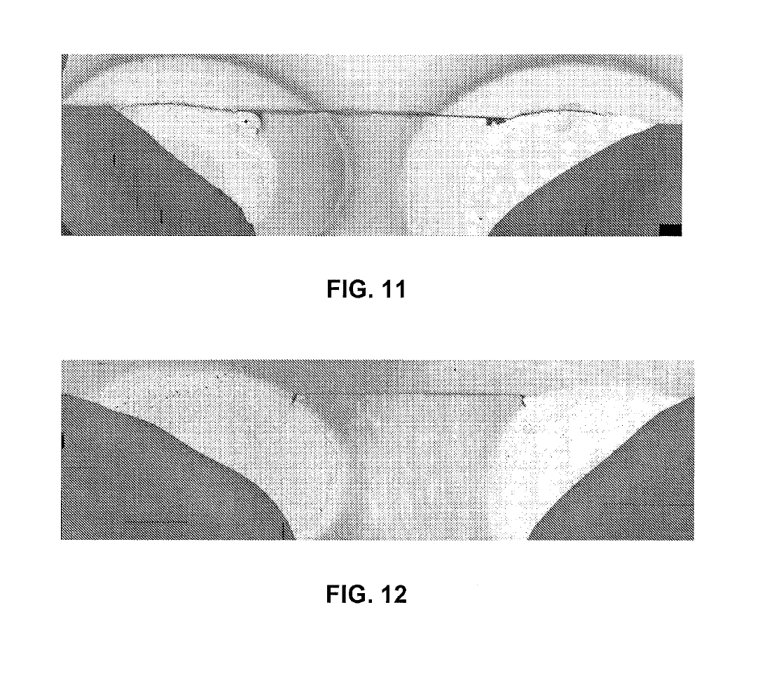

FIG. 11 shows a cross-sectional macrograph through a weldment produced with an AA 7085 aluminum alloy base metal and an Al—Mg weld filler wire in accordance with one embodiment of the present disclosure. In this instance, some cracking may be observed around the weldment.

FIG. 12 shows a cross-sectional macrograph through a weldment produced with a modified AA 7085 aluminum alloy base metal and an Al—Mg weld filler wire in accordance with one embodiment of the present disclosure. In this instance, very little cracking may be observed around the weldment.

Aluminum Association 6xxx and 5xxx Series Aluminum Alloys

Fusion welding of AA 6013 aluminum alloy base metal to itself or to AA 5083 aluminum alloy base metal with AA 4043 and AA 4047 aluminum weld filler alloys may be problematic because the welds (e.g., weld deposits) produced with these weld filler alloys may be relatively weak (e.g., low shear and tensile strengths). In addition, the silicon content in these weld filler alloys may form fine, isolated (e.g., non-continuous) and brittle inter-metallic Mg₂Si materials at the fusion zones or in the welds adjacent the AA 5083 aluminum alloy base metal. Under certain applications (e.g., fatigue, blast), this inter-metallic Mg₂Si material may adversely affect the structural performance of the welds. In order to increase weld strength and eliminate the formation of the brittle inter-metallic Mg₂Si material, it would be more desirable to be able to weld AA 6013 aluminum alloy base metal to itself or to AA 5083 aluminum alloy base metal with a aluminum-magnesium-based (e.g., 5xxx series) weld filler alloy, which may be stronger and does not entail the formation of the inter-metallic Mg₂Si material.

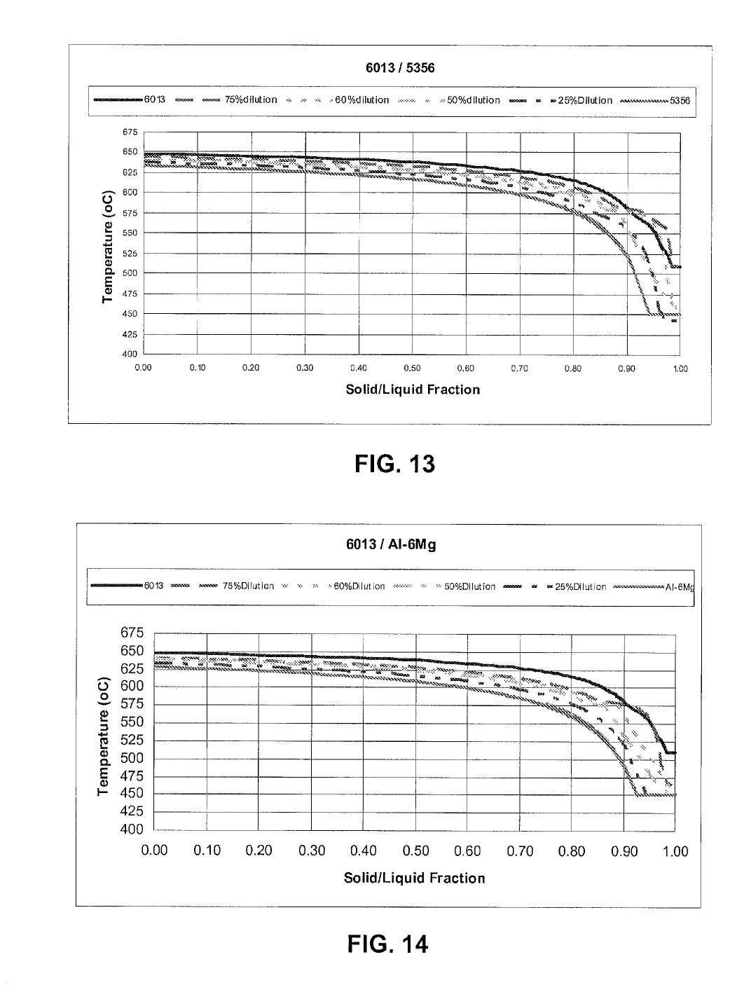

FIG. 13 illustrates a comparison of solidus temperatures between an AA 6013 aluminum alloy base metal and a weld produced with an AA 5356 aluminum weld filler alloy at different solid/liquid fractions, with varying percentage of dilution of the AA 6013 aluminum alloy base metal and the AA 5356 aluminum weld filler alloy within the weld.

As shown in FIG. 13, the solidus temperatures of the AA 5356 weld filler alloy, along with various dilution ratios of the AA 6013 aluminum alloy base metal and the AA 5356 weld filler alloy into the weld, are generally lower than the AA 6013 aluminum alloy base metal at nearly all solid/liquid fractions. However, at 60% and 75% dilution ratios of the AA 6013 aluminum alloy base metal into the weld, the solidus temperatures of the weld intersect the solidus temperatures of the AA 6013 aluminum alloy base metal (e.g., at solid/liquid fraction of about 0.90 and about 575° C.). In other words, the AA 5356 weld filler alloy may not be suitable for joining or repairing AA 6013 aluminum alloy base metals because at some dilution ratios of the AA 6013 aluminum alloy base metal into the weld (e.g., 60% and 75% dilution ratios), the solidus temperatures of the weld with these dilution ratios may exceed the solidus temperatures of the AA 6013 aluminum alloy base metal thereby leading to tearing and cracking of the weld.

FIG. 14 illustrates a comparison of the solidus temperatures between an AA 6013 aluminum alloy base metal and a weld produced with an Al—Mg weld filler alloy according to one embodiment of the present disclosure at different solid/liquid fractions, with varying percentage of dilution of the AA 6013 aluminum alloy base metal and the Al—Mg weld filler alloy within the weld.

As shown in FIG. 14, the solidus temperatures of the Al—Mg weld filler alloy, along with various dilution ratios of the AA 6013 aluminum alloy base metal and the Al—Mg weld filler alloy into the weld, are generally lower than the AA 6013 aluminum alloy base metal across substantially all solid/liquid fractions, except a slight overlap for the 75% dilution ratio at higher solid/liquid fractions (e.g., from about 0.90 to about 0.95) and lower temperatures (e.g., from about 575° C. to about 525° C.). In other words, the Al—Mg weld filler alloy according to one embodiment of the present disclosure is able to produce weld deposits having solidus temperatures that are generally lower than those of the AA 6013 aluminum alloy base metal, and would therefore be a generally acceptable weld filler alloy for welding, joining or repairing AA 6013 aluminum alloy base metal to itself or to AA 5083 aluminum alloy base metal without causing a great amount of cracking and/or tearing at the weld deposits.

In some embodiments, the Al—Mg weld filler alloy according to one embodiment of the present disclosure is an effective weld filler wire or rod because: (a) the grains in parts (e.g., extrusions, sheet, plates, forgings) made of AA 6013 aluminum alloy do not grow at their HAZs as much as the grains at the HAZs in the AA 7085 aluminum alloy; and (b) the eutectics in AA 6013 aluminum alloy melts along the grain boundaries at a higher temper (e.g., about 510° C.) than the eutectics in AA 7085 aluminum alloy (e.g., about 476° C.), with hot-cracking along nearly continuous and connected grain boundaries through partially molten low melting eutectics being not as much of an issue as with AA 7085 aluminum alloy. Consequently, the Al—Mg weld filler alloy according to one embodiment of the present disclosure is capable of producing welds for fusion welding an AA 6013 aluminum alloy base metal to itself or to an AA 5083 aluminum alloy base metal.

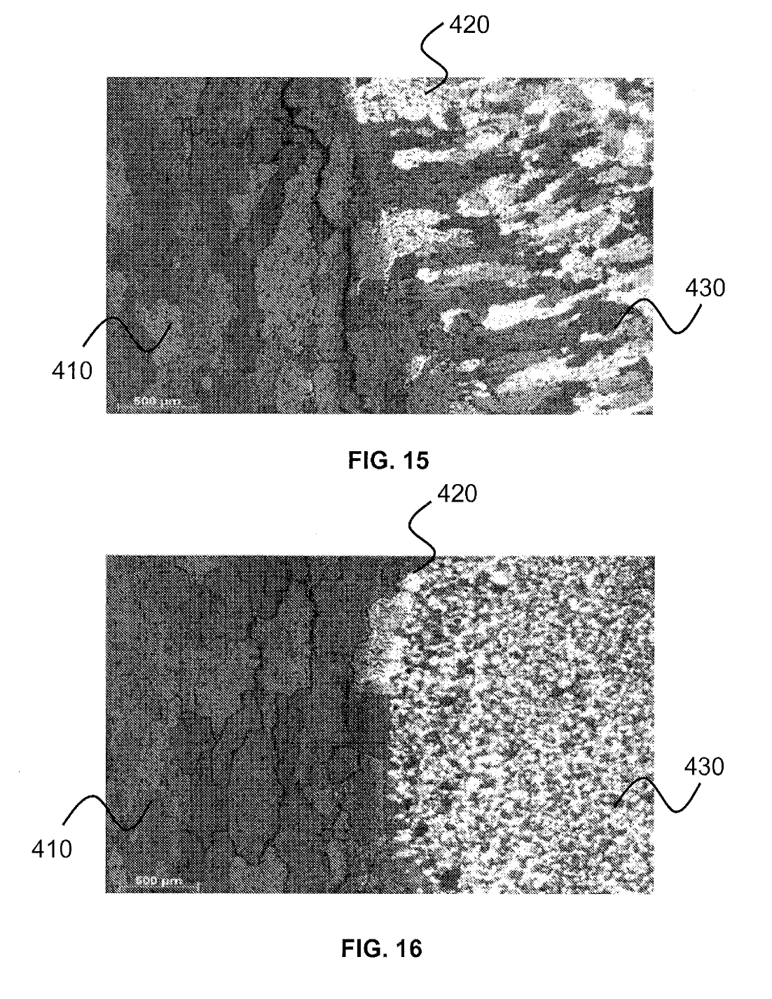

FIG. 15 shows a photomicrograph at 500 times magnification of an AA 6013-T6 aluminum alloy base metal 410 welded to an AA 5356 aluminum weld filler wire/weld metal 430 via a fusion zone 420, where the fusion zone 420 includes a combination of the AA 6013-T6 aluminum alloy base metal 410 and the AA 5356 aluminum weld filler wire/weld metal 430. This cross-section is of a weldment 420 produced by manual gas tungsten arc welding (GTAW) with an end constrained tee-fillet type of joint. The microstructures of the weldment 420 are in general course and rough with relatively large grains. As discussed above, larger grains have a tendency to tear (e.g., crack) when a weld solidifies.

FIG. 16 shows a photomicrograph at 500 times magnification of a weldment produced with the standard 6013-T6 with reference numeral 410, a fusion zone having a combination of the AA 6013-T6 aluminum alloy base metal with an Al—Mg weld filler wire/weld metal according to one embodiment of the present disclosure with reference numeral 420, and the Al—Mg weld filler wire/weld metal with reference numeral 430. This cross-section is of a weldment 420 produced by manual gas tungsten arc welding (GTAW) with an end constrained tee-fillet type of joint. The microstructures of the weldment 420 have more pronounced refinement compared to that of FIG. 15, with generally smaller and finer grain sizes. As discussed above, smaller grains have are not as likely to tear (e.g., crack) when a weld solidifies.

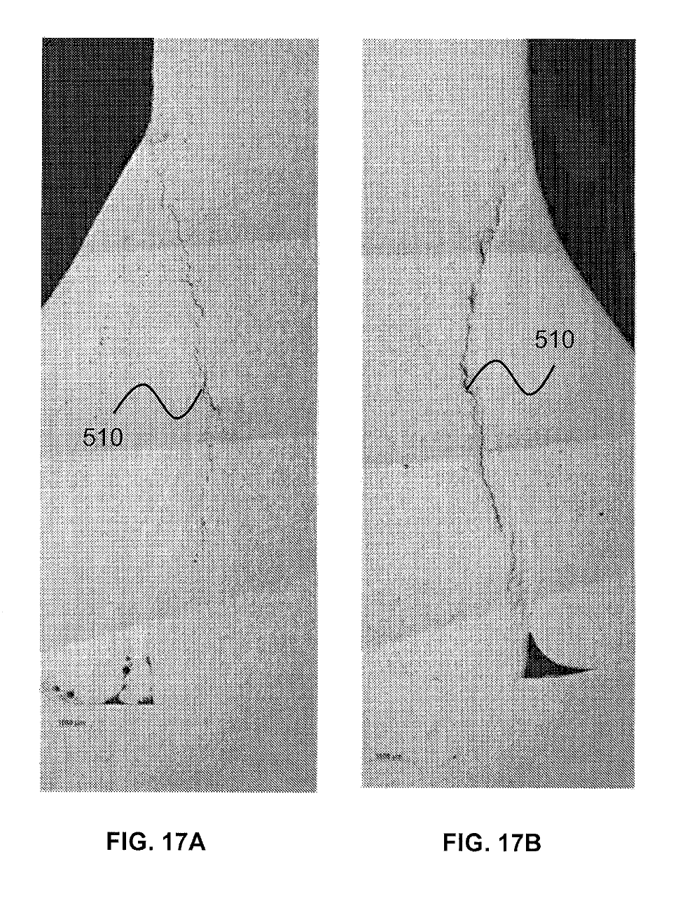

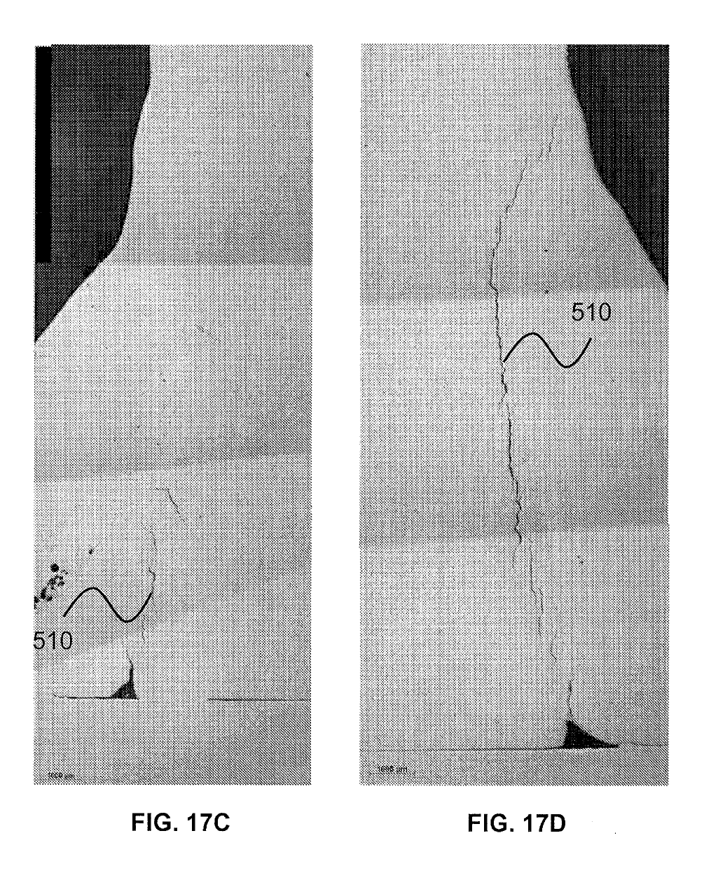

FIGS. 17A-17D show photomicrographs at 12 times magnification of two different sets of cross-sectional views of tee-fillet type weldments produced with an AA 6013-T6 aluminum alloy base metal and an AA 5356 weld filler wire. As shown in the figures, cracks 510 may be observed in the AA 6013-T6 base metal in the HAZs next to the fusion zones.

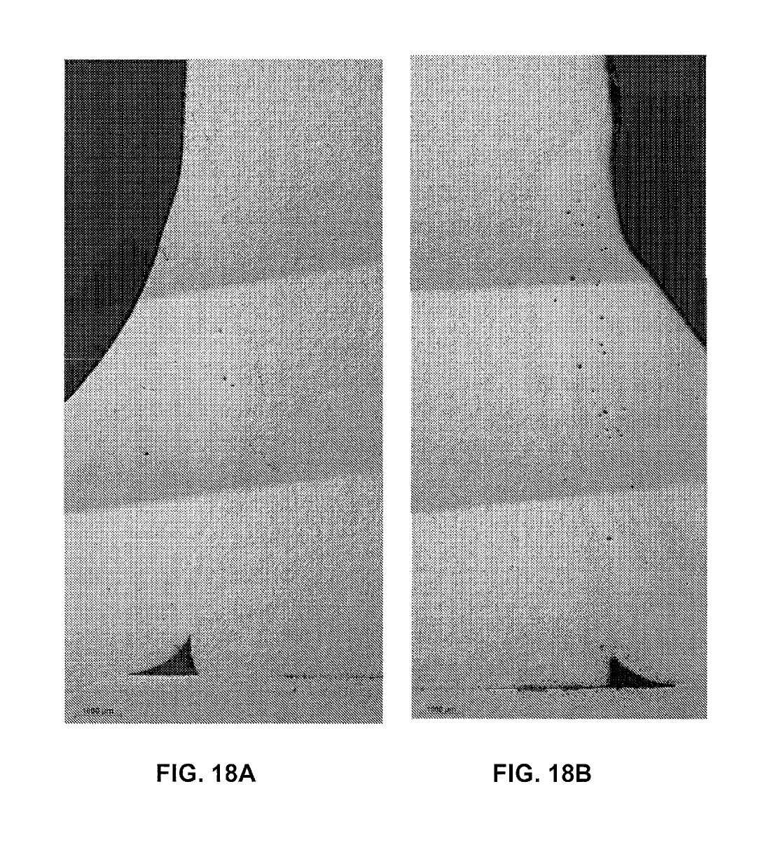

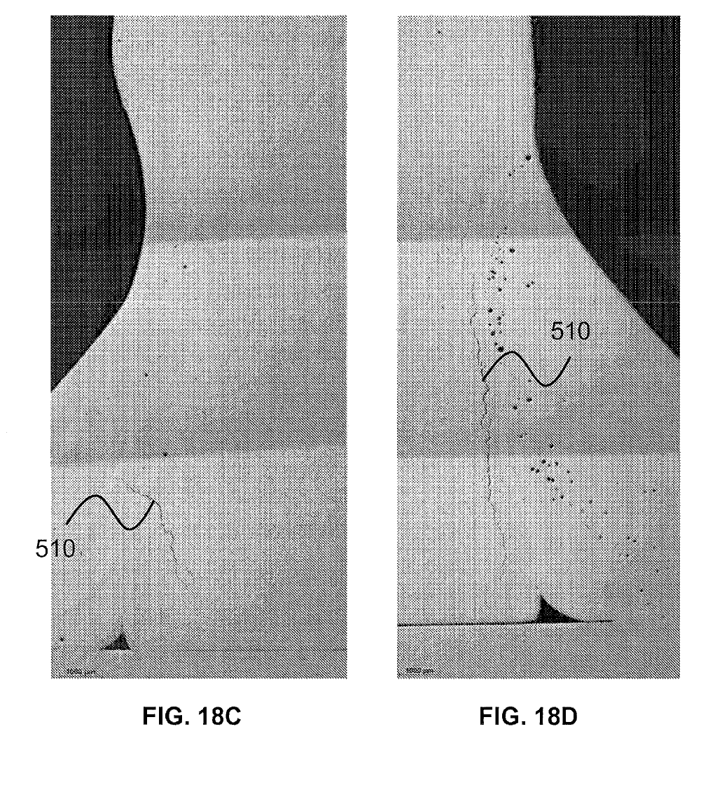

FIGS. 18A-18D show photomicrographs at 12 times magnification of two different sets of cross-sectional views of tee-fillet type weldments produced with an AA 6013-T6 aluminum alloy base metal and a modified AA 5356 weld filler wire. In one instance, the modification includes altering grain refiners including the likes of TiB₂, among others. Although the weldment in FIGS. 18A and 18B is substantially free of cracks, cracks 510 may be observed in the AA 6013-T6 base metal in the HAZs next to the fusion zones in FIGS. 18C and 18D.

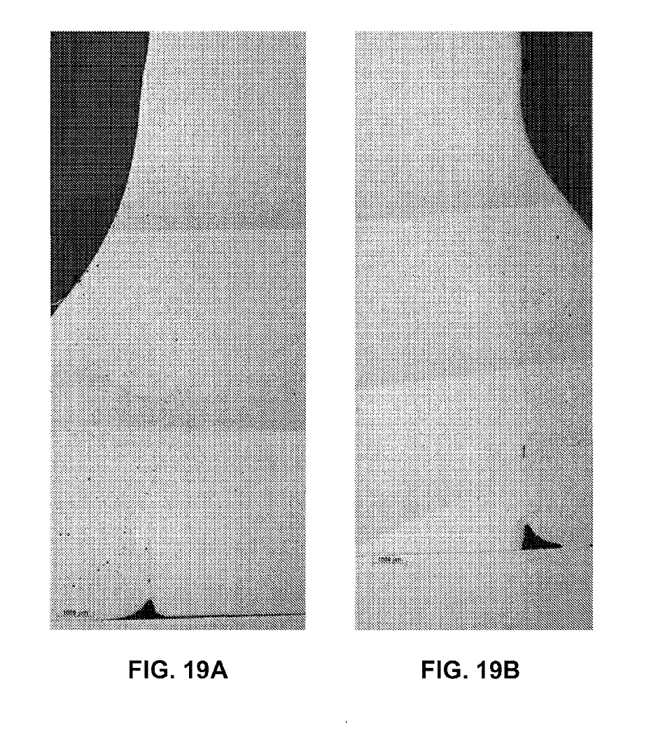

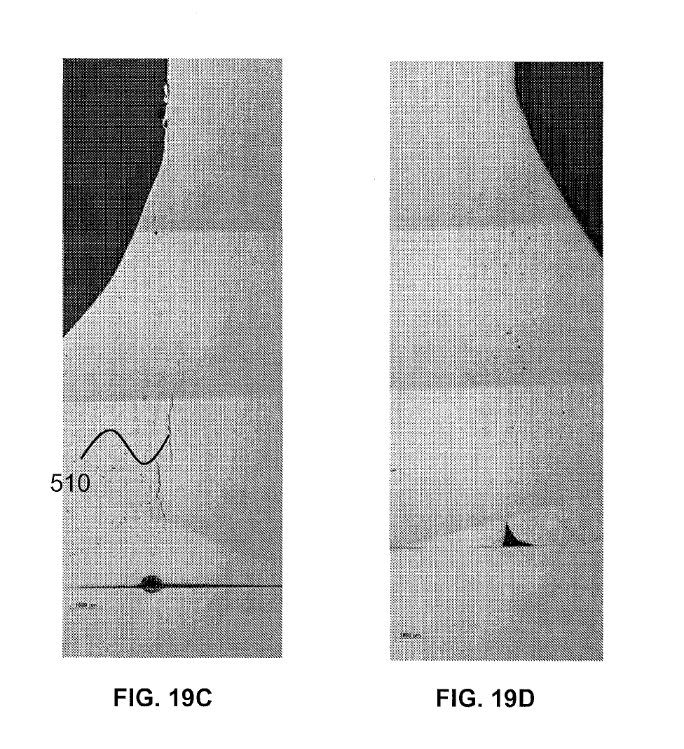

FIGS. 19A-19D show photomicrographs at 12 times magnification of two different sets of cross-sectional views of tee-fillet type weldments produced with an AA 6013-T6 aluminum alloy base metal and an AA 4043 weld filler wire. Although the weldment in FIGS. 19A and 19B is substantially free of cracks, cracks 510 may be observed in the AA 6013-T6 base metal in the HAZs next to the fusion zones in FIGS. 19C and 19D. And as discussed above, because the 4xxx series generally have better weldability than 5xxx series weld filler alloys, the cracks in FIG. 19C are generally shorter and smaller than those of FIGS. 17A-17D and FIGS. 18C-18D.

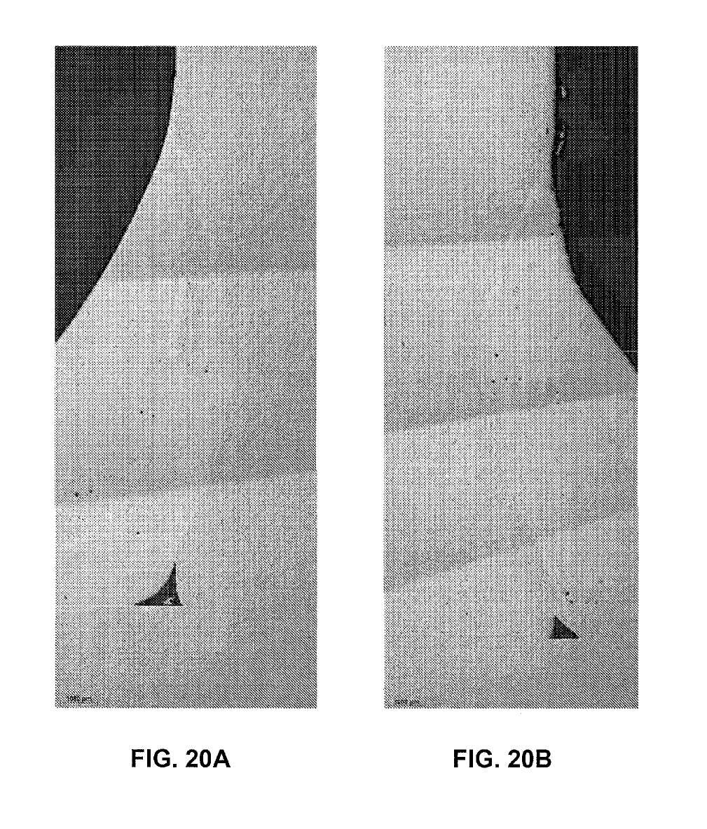

FIGS. 20A and 20B show photomicrographs at 12 times magnification of cross-sectional views of a tee-fillet type weldment produced with an AA 6013-T6 aluminum alloy base metal and an Al—Mg weld filler wire according to one embodiment of the present disclosure. As shown, there are no cracks visible in the base metal and/or the weldment.

In general, when welding AA 6013 aluminum alloy base metals with an Al—Mg weld filler alloy or an Al—Mg—Zn weld filler alloy according to one embodiment of the present disclosure, the solidification temperatures of the weld filler alloy are lower than the solidification temperatures of the AA 6013 base metal as the solid/liquid fraction approaches 1.00. This means that generally, most of the weld in the fusion zones and the HAZs will solidify after the AA 6013 base metal thereby leading to fewer tears and cracks.

In some instances, high percentage of copper in the AA 6013 base metal may combine with magnesium to form a low melting eutectic phase, which may have a tendency to crack under weld-induced solidification shrinkage and residual stress, especially in the welds and in their fusion lines. Whenever the solidus temperature of a weld, at its final solidification (e.g., solid/liquid fraction approaching 1.00) exceeds the solidification temperature of the base metal being welded (e.g., AA 6013, AA 6091), the weld may solidify before the partially molten base metal at the weld, thus making the partially molten base metal weaker than the solidified weld, and more prone to cracking.

Aluminum Association 2xxx Series Aluminum Alloys

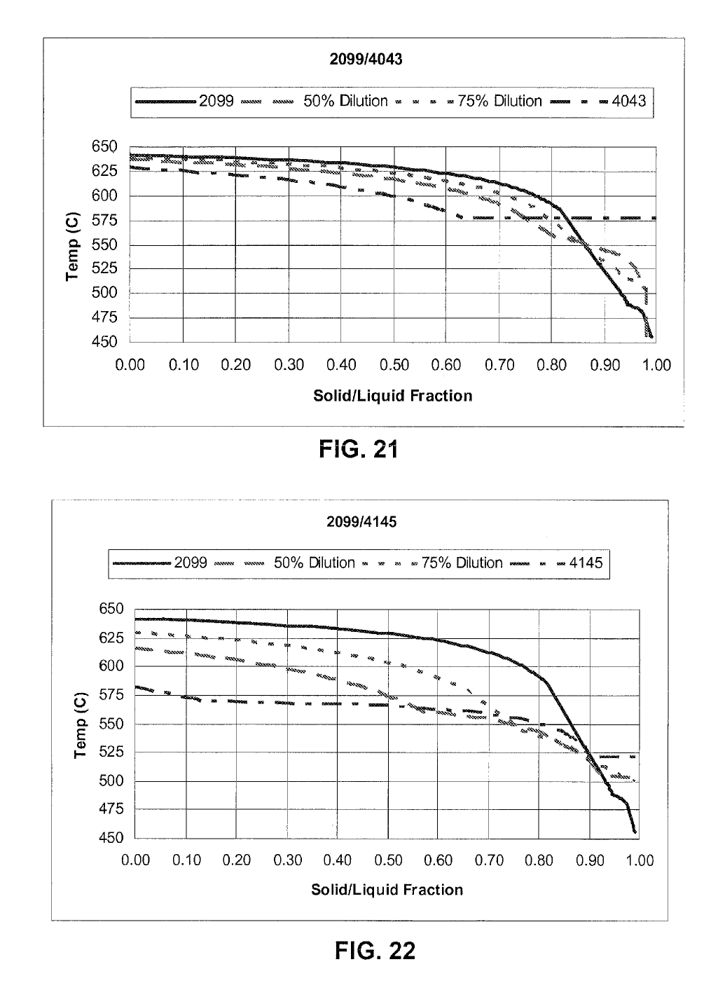

FIG. 21 illustrates a comparison of the solidus temperatures between an AA 2099 aluminum alloy base metal and a weld produced with an AA 4043 aluminum weld filler alloy at different solid/liquid fractions, with varying percentage of dilution of the AA 2099 aluminum alloy base metal and the AA 4043 aluminum weld filler alloy within the weld.

As shown in FIG. 21, when a weld deposit is solidifying, the AA 4043 weld filler alloy has the tendency to solidify before the AA 2099 base metal and at various dilution ratios (e.g., at relatively high temperatures and low solid/liquid fractions). However, as the weld deposit continues cooling to about 575° C., the solid content within the AA 4043 weld filler alloy suddenly jumps from about 60% to about 100% (e.g., the flat line portion of the 4043 line). From this point forward (e.g., temperatures not greater than about 575° C.), the weld deposit may start to exhibit cracking due to more of the AA 4043 weld filler alloy solidifying (e.g., about 100% solid) than the AA 2099 base metal (e.g., about 80% solid). Furthermore, even the solidus temperatures of the various dilution ratios, beyond about 85% solid/liquid fractions, exceed that of the AA 2099 base metal. This behavior is substantially similar to those of the AA 7085 aluminum alloy base metal from above and suggests that the AA 4043 weld filler alloy may not be a suitable material for the AA 2099 base metal because of possible crack formation.

Likewise, as shown in FIG. 22, the AA 4145 weld filler alloy exhibits similar trends as that of the AA 4043 weld filler alloy where the intersection and cross-over of the AA 4145 weld filler alloy and the various dilution ratios, with respect to the AA 2099 base metal, occur at about 90% solid/liquid fraction and temperatures of not greater than about 525° C.

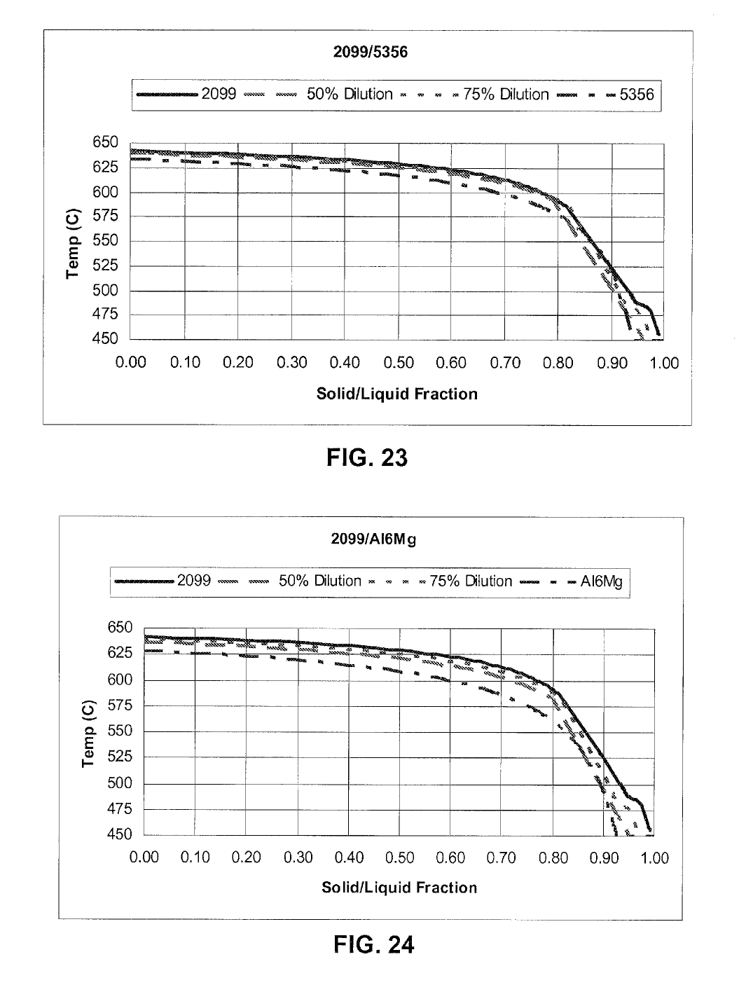

FIG. 23 illustrates a comparison of solidus temperatures between an AA 2099 aluminum alloy base metal and a weld produced with an AA 5356 aluminum weld filler alloy at different solid/liquid fractions, with varying percentage of dilution of the AA 2099 aluminum alloy base metal and the AA 5356 aluminum weld filler alloy within the weld.

As shown in FIG. 23, the solidus temperatures of the AA 5356 weld filler alloy, along with various dilution ratios of the AA 2099 aluminum alloy base metal and the AA 5356 weld filler alloy into a weld, are generally lower than the AA 2099 aluminum alloy base metal at nearly all solid/liquid fractions. However, at about 75% dilution ratio of the AA 2099 aluminum alloy base metal into the weld, the solidus temperatures of the weld intersect the solidus temperatures of the AA 2099 aluminum alloy base metal (e.g., at solid/liquid fraction of about 0.85 and about 575° C.). In other words, AA 5356 weld filler alloy may be a suitable welding material for the AA 2099 base metal for the most part, but not at all dilution ratio of the AA 2099 base metal into the weld (e.g., not suitable at about 75% dilution ratio) because of the intersecting solidus temperature.

FIG. 24 illustrates a comparison of solidus temperatures between an AA 2099 aluminum alloy base metal and a weld produced with an Al—Mg weld filler alloy according to one embodiment of the present disclosure at different solid/liquid fractions, with varying percentage of dilution of the AA 2099 aluminum alloy base metal and the Al—Mg weld filler alloy within the weld.

As shown in FIG. 24, the solidus temperatures of the Al—Mg weld filler alloy, along with various dilution ratios of the AA 2099 aluminum alloy base metal and the Al—Mg weld filler alloy into a weld, are generally lower than the AA 2099 aluminum alloy base metal across substantially all solid/liquid fractions. In other words, the Al—Mg weld filler alloy according to one embodiment of the present disclosure is able to produce weld deposits having solidus temperatures that are generally lower than those of the AA 2099 aluminum alloy base metal, and would therefore be a generally acceptable weld filler alloy for welding, joining or repairing AA 2099 aluminum alloy base metal to itself or to other aluminum alloy base metal without severe cracking.

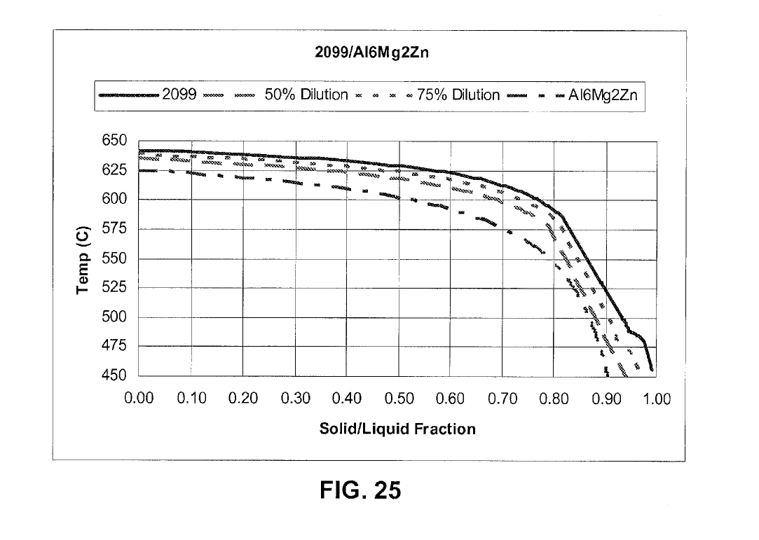

Likewise, as shown in FIG. 25, the solidus temperatures of an Al—Mg—Zn weld filler alloy according to one embodiment of the present disclosure may be generally lower than those of the AA 2099 aluminum alloy base metal, without any intersection and/or cross-over. This means that the Al—Mg—Zn weld filler alloy, according to one embodiment of the present disclosure, may be a generally acceptable weld filler alloy for welding, joining or repairing AA 2099 aluminum alloy base metal to itself or to other aluminum alloy base metal without severe cracking.

Weld Properties

In one embodiment, an Al—Mg aluminum weld filler alloy according to one embodiment of the present disclosure is capable of fusion welding a first AA 6013-T6 aluminum alloy base metal to a second. AA 6013-T6 aluminum alloy base metal. In one embodiment, an Al—Mg aluminum weld filler alloy according to one embodiment of the present disclosure is capable of fusion welding an AA 6013-T6 aluminum alloy base metal to an AA 5083-H32 aluminum alloy base metal.

In some instances, the Al—Mg and the Al—Mg—Zn weld filler alloys according to the present disclosure are capable of producing weldments with improved tension and transverse shear, with improved percent ductility, and with improved blast resistance, among other properties.

In some embodiments, the longitudinal tensile strengths of welds produced with an Al—Mg aluminum weld filler alloy may be stronger than the strength of welds produced with AA 4043 weld filler alloys (e.g., 288 MPa v. 198 MPa) and slightly stronger than the strength of welds produced with AA 5184 weld filler alloys (e.g., 288 MPa v. 281 MPa). In some embodiments, the yield strengths of welds produced with an Al—Mg aluminum weld filler alloy may be stronger than the strength of welds produced with AA 4043 weld filler alloys (e.g., 152 MPa v. 92 MPa) and comparable to the strength of welds produced with AA 5184 weld filler alloys (e.g., 152 MPa v. 150 MPa).

Some mechanical properties of the weld filler alloys are shown in Table 3.

TABLE 3
Mechanical Properties of Various Weld Filler Alloys

| Weld Filler | Yield Strength | Tensile Strength | Elongation |
|---|---|---|---|
| Alloys | (MPa) | (MPa) | (%) |
| AA 5183 | 150 | 281 | 27.4 |
| AA 4043 | 92 | 198 | 19.1 |
| Al—Mg | 152 | 288 | 21.7 |

In some instances, the transverse tensile strengths of the AA 6013-T6 base metal weldments produced with the Al—Mg weld filler alloy may be comparable to those produced with the AA 4043 weld filler alloy. In other instances, the ductility of the former may be somewhat lower than the latter because welds produced with the Al—Mg weld filler alloys may be more porous.

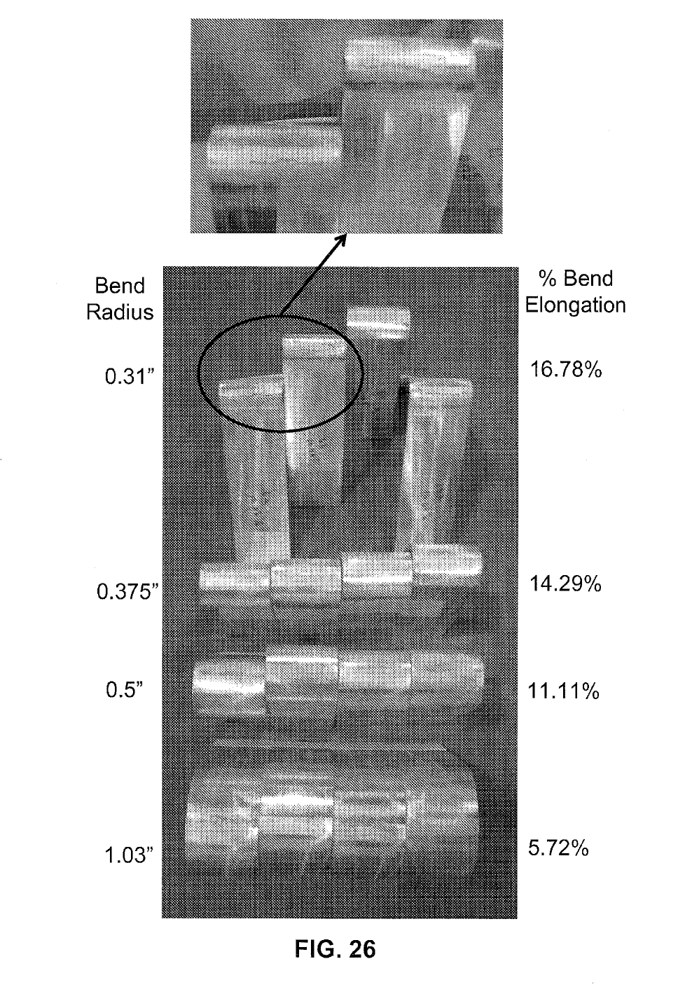

FIG. 26 comprises a plurality of photographs of bend specimens of AA 6013 aluminum alloy base metal welded with an AA 4043 weld filler alloy. The bend specimens may be generated using a wrap-around bend test. As shown, the AA 6013 base metals with AA 4043 weld filler wires are capable of achieving a maximum bend radius of about 0.375 inch and a maximum elongation of about 14.29% before cracking becomes visible at a weldment with a bend radius of about 0.31 inch and an elongation of about 16.78% (best shown in the inset).

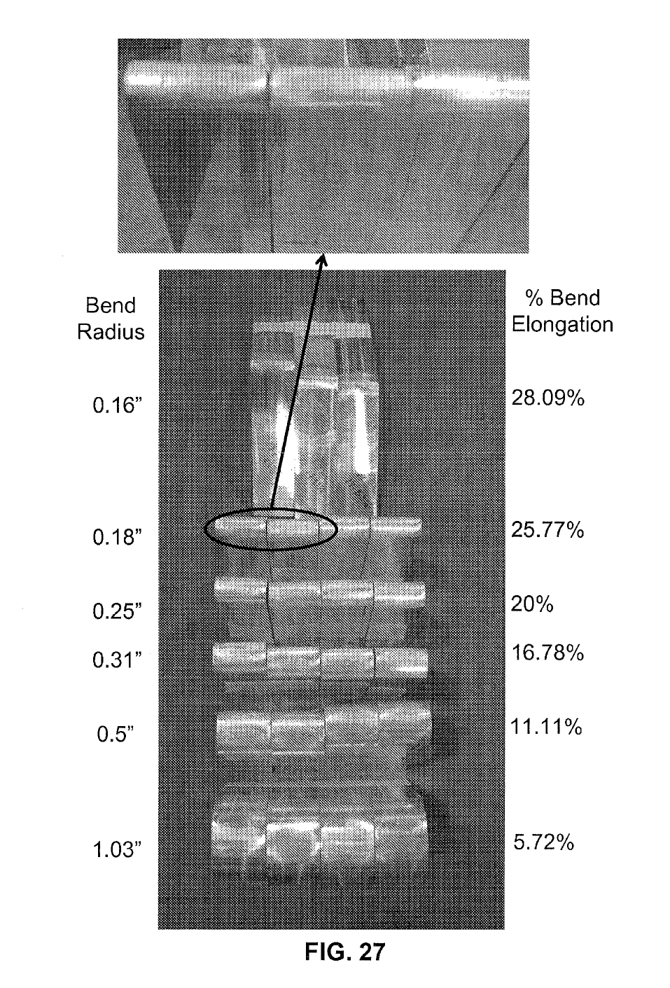

FIG. 27 comprises a plurality of photographs of bend specimens of AA 6013 aluminum alloy base metal welded with an Al—Mg weld filler alloy according to one embodiment of the present disclosure. The bend specimens may be generated using a wrap-around bend test. As shown, the AA 6013 base metals welded with the Al—Mg weld filler wires are capable of achieving a maximum bend radius of at least about 0.18 inch and a maximum elongation of at least about 25.77% with no visible signs of tearing at a weldment (best shown in the inset).

In some embodiments, the percent bend-elongation of a butt-type weld of a first AA 6013 aluminum alloy base metal welded to a second AA 6013 aluminum alloy base metal using an Al—Mg weld filler alloy according to one embodiment of the present disclosure may be about two times higher than the percent bend-elongation of a similar weld with the AA 4043 weld filler alloy.

In one embodiment, mass loss criteria under ASTM G67 standard may demonstrate that a weld produced with AA 6013-T6 parts and an Al—Mg weld filler alloy may exhibit a smaller mass-loss than the AA 6013-T6 base metals and their HAZs upon one week exposure to about 100° C. In one embodiment, a similar weld between an AA 5083-H32 part and an AA 6013-T6 part with Al—Mg weld filler alloy may exhibit comparable mass-loss to both the AA 5083-H32 base metal and the 6013-T6 base metal, and their respective HAZs.

### Experimental Procedures

The following procedure may be used to demonstrate fusion-based weld repair procedure and fusion weldability with the aforementioned base metal/filler alloy combinations:

(1) Optionally clean the aluminum part to be welded with a solvent;

(2) Lightly brush surface oxides off the aluminum part at a joint area;

(3) Tack weld the aluminum parts together into a end-constrained double fillet-tee joint mockup; and

(4) Manually deposit two opposing fillet welds using gas tungsten arc welding (GTAW) process.

The following welding parameters may be used for the GTAW process:

(i) Current—from about 230 amperes to about 250 amperes

(ii) Voltage—from about 22 volts to about 24 volts

(iii) Speed of travel—from about 4 inches per minute to about 6 inches per minute

(iv) Shielding gas—welding grade argon

(v) Gas flow rate—about 50 cubic feet per hour

(vi) Interpass weld temperature—about 43° C. (about 110° F.)

In one example, the base metal parts being welded may be about half-inch thick plates with existing 5xxx or 4xxx series weld filler alloys or with an Al—Mg or an Al—Mg—Zn weld filler alloy composition (e.g., in wire or rod form) according to one embodiment of the present disclosure.

For example, to produce end-constrained double fillet-tee joints with modified AA 7085 aluminum alloy plates, the plates may first be machined to a required dimension (e.g., about 12 inches long by 8 inches wide and half-inch thick). The parts to be welded are subsequently cleaned with a solvent and dried. A horizontal plate is placed onto a welding table and firmly held down against the table with clamps. The long edge of a vertical plate is placed over the horizontal plate and positioned at its mid-width. The two joint areas to be welded are lightly brushed with a stainless steel brush, cleaned with a solvent and dried. The end-constraining plates are brought to the ends of a T(tee) formed between the two plates and manually tack-welded to the end edges of the horizontal and vertical plates. Manually GMA weld the end-constraining plates to the horizontal and vertical plates by depositing fillet joints between them to complete the assembly of the end-constrained tee joint mockup.

Manually GMA weld the tee joint formed between the two plates by depositing two opposing fillet welds while maintaining approximately 110° F. pre-heat and interpass temperature. The weldment is subsequently allowed to cool to room temperature. To test the soundness of the weldment, the weld may be brushed and visually inspected to make sure that there are no open surface discontinuities. Once the completed weldment is removed from the holding clamps, a user can inspect the two welds with dye penetrant for soundness and/or radiograph the two welds for internal soundness (e.g., no internal discrepant features such as cracks, excessive porosity). A user may also proceed to test the weldment in various ways (e.g., cross-sectioning of welds).

The following weld procedure may be used to demonstrate the fusion-based weld repair procedure with the aforementioned base metal/filler alloy combinations:

(1) Grind the defective cracked area on the part and/or weld until the crack is not detectable with visual and dye-penetrant tests;

(2) Clean the grounded area(s) with solvent;

(3) Manually deposit multiple weld passes using the gas tungsten arc welding (GTAW) process until the grounded areas are filled and weld reinforcements are formed above the affected area; and

(4) Grind the weld reinforcement flush with the top surface of the affected part and/or weld and blend the ground area with its adjacent surrounding.

The following welding parameters may be used for the GTAW process:

(i) Current—from about 190 amperes to about 230 amperes

(ii) Voltage—from about 22 volts to about 24 volts

(iii) Speed of travel—from about 4 inches per minute to about 6 inches per minute

(iv) Shielding gas—welding grade argon

(v) Gas flow rate—about 50 cubic feet per hour

(vi) Interpass weld temperature—about 43° C. (about 110° F.)

While specific embodiments of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the appended claims and any and all equivalents thereof.

What is claimed is:

1. A weld filler alloy comprising:
from about 5.6 wt. % Mg to about 8.0 wt. % Mg;
from about 0.01 wt. % to about 0.5 wt. % of a grain refiner; and
up to about 94.4 wt. % Al.

2. The weld filler alloy of claim 1 having from about 5.6 wt. % Mg to about 6.2 wt. % Mg.

3. The weld filler alloy of claim 1 having about 5.9 wt. % Mg.

4. The weld filler alloy of claim 1, further comprising:
from about 0.05 wt. % Zn to about 3.5 wt. % Zn.

5. The weld filler alloy of claim 4 having about 1.7 wt. % Zn to about 2.3 wt. % Zn.

6. The weld filler alloy of claim 4 having about 2.0 wt. % Zn.

7. The weld filler alloy of claim 1, wherein the grain refiner is at least one of Zr, Ti and B.

8. The weld filler alloy of claim 1, wherein the weld filler alloy is substantially free of Mn.

9. A product comprising:
a first aluminum alloy segment;
a second aluminum alloy segment; and
a weldment joining the first aluminum alloy segment to the second aluminum alloy segment, wherein the weldment comprises a weld filler alloy having from about 5.6 wt. % Mg to about 8.0 wt. % Mg, from about 0.01 wt. % to about 0.5 wt. % of a grain refiner, and up to about 94.4 wt. % Al.

10. The product of claim 9, wherein the weld filler alloy includes from about 0.05 wt. % Zn to about 3.5 wt. % Zn.

11. The product of claim 9, wherein each of the first aluminum alloy segment and the second aluminum alloy segment comprises at least one of a 6xxx series aluminum alloy.

12. The product of claim 9, wherein each of the first aluminum alloy segment and the second aluminum alloy segment comprises at least one of a 5xxx series aluminum alloy.

13. The product of claim 9, wherein each of the first aluminum alloy segment and the second aluminum alloy segment comprises at least one of a 7xxx series aluminum alloy.

14. The product of claim 9, wherein each of the first aluminum alloy segment and the second aluminum alloy segment comprises at least one of a 2xxx series aluminum alloy.

15. The product of claim 9, wherein the weldment achieves cracks of not greater than about 0.1 mm.

16. A method comprising:
(a) providing first aluminum product and second aluminum product proximal to each other;
(b) providing a weld filler alloy proximal to the first aluminum product and the second aluminum product, wherein the weld filler alloy comprises from about 5.6 wt. % Mg to about 8.0 wt. % Mg, from about 0.01 wt. % to about 0.5 wt. % of a grain refiner, and up to about 94.4 wt. % Al; and
(c) welding the first aluminum product and the second aluminum product together by at least one of melting and fusing the first aluminum product, the second aluminum product and the weld filler alloy, wherein the solidus temperature of the weld filler alloy is lower than the solidus temperature of the first aluminum product and the second aluminum product.

17. The method of claim 16, wherein the weld filler alloy includes from about 0.05 wt. % Zn to about 3.5 wt. % Zn.

18. The method of claim 16, wherein each of the first aluminum product and the second aluminum product comprises at least one of a 6xxx series aluminum alloy.

19. The method of claim 16, wherein each of the first aluminum product and the second aluminum product comprises at least one of a 5xxx series aluminum alloy.

20. The method of claim 16, wherein each of the first aluminum product and the second aluminum product comprises at least one of a 7xxx series aluminum alloy and a 2xxx series aluminum alloy.
